(19) United States
(12) Patent Application Publication
(10) Pub. No.: US 2021/0270951 A1
(43) Pub. Date: Sep. 2, 2021

(54) COMMUNICATION DEVICE AND COMMUNICATION METHOD

(71) Applicant: SONY CORPORATION, TOKYO (JP)

(72) Inventor: ATSUSHI YOSHIZAWA, TOKYO (JP)

(21) Appl. No.: 17/250,364

(22) PCT Filed: Jul. 12, 2019
(86) PCT No.: PCT/JP2019/027809

§ 371 Date: Jan. 11, 2021

(30) Foreign Application Priority Data
Jul. 20, 2018 (JP) 2018-136418

(51) Int. Cl. G01S 13/34; G01S 7/35; G01S 7/36; H04W 4/40; H04W 72/12

(52) U.S. Cl. CPC G01S 13/34; G01S 7/35; H04W 72/1205; H04W 4/40; G01S 7/36

(57) ABSTRACT

A communication device includes: a communication section (220) that performs wireless communication; an acquisition section (243) that acquires, from another communication device through the wireless communication, information regarding detection of an object based on reflected waves obtained by reflection of a transmitted wireless signal from the object; and a control section (245) that controls an operation related to the detection on the basis of the acquired information.

### TECHNICAL FIELD

The present disclosure relates to a communication device and a communication method.

### BACKGROUND ART

An in-vehicle radar is one of the important elemental technologies for realizing driving support and automatic driving of mobile objects such as automobiles and the like. The in-vehicle radar is one of the key devices in an in-vehicle sensing technology, along with cameras and lidar (light detection and ranging) that are intended for in-vehicle use. For example, Patent Document 1 discloses an example of a technology for realizing the in-vehicle radar.

Furthermore, in recent years, the use of a wireless signal having a frequency of 76 GHz to 77 GHz or 77 GHz to 81 GHz has been studied for such an in-vehicle radar, the wireless signal being called millimeter waves (hereinafter, also simply referred to as “millimeter waves”). In particular, a radar using millimeter waves has become of interest for applications in in-vehicle radars, due to expected effects such as making it easier to realize a high-gain array antenna as the antenna becomes smaller, improving the distance resolution, and the like.

### CITATION LIST

### Patent Document

Patent Document 1: Japanese Patent Application Laid-Open No. 2007-187632

### SUMMARY OF THE INVENTION

### Problems to be Solved by the Invention

A general in-vehicle radar, for example, transmits a wireless signal to the surroundings and detects an object by using a result of reception of reflected waves obtained by reflection of the wireless signal from the object and the like. From such characteristics, for example, in a situation where each mobile object transmits a wireless signal, it can be assumed that interference occurs due to unintentional reception of a wireless signal transmitted from another vehicle. The effects of such interference may become more apparent easily with the spread of the in-vehicle radar.

Therefore, the present disclosure proposes a technology that enables object detection using a wireless signal in a more preferable manner.

### Solutions to Problems

According to the present disclosure, a communication device includes: a communication section that performs wireless communication; an acquisition section that acquires, from another communication device through the wireless communication, information regarding detection of an object based on reflected waves obtained by reflection of a transmitted wireless signal from the object; and a control section that controls an operation related to the detection on the basis of the acquired information.

Furthermore, according to the present disclosure, a communication device includes: a communication section that performs wireless communication; and a notification section that notifies a terminal device of information regarding detection of an object based on reflected waves obtained by reflection of a transmitted wireless signal from the object, through the wireless communication.

Furthermore, according to the present disclosure, a communication method performed by a computer includes: performing wireless communication; acquiring, from another communication device through the wireless communication, information regarding detection of an object based on reflected waves obtained by reflection of a transmitted wireless signal from the object; and controlling an operation related to the detection on the basis of the acquired information.

Furthermore, according to the present disclosure, a communication method performed by a computer includes: performing wireless communication; and notifying a terminal device of information regarding detection of an object based on reflected waves obtained by reflection of a transmitted wireless signal from the object, through the wireless communication.

### Effects of the Invention

As described above, the present disclosure provides a technology that enables object detection using a wireless signal in a more preferable manner.

Note that effects of the present disclosure are not necessarily limited to the effects described above, and, along with or instead of the effects described above, any of the effects shown in the present specification, or other effects that can be grasped from the present specification may be achieved.

### BRIEF DESCRIPTION OF DRAWINGS

FIG. 1 is an explanatory diagram for describing an example of a schematic configuration of a system according to an embodiment of the present disclosure.

FIG. 2 is a block diagram illustrating an example of a configuration of a base station according to the embodiment.

FIG. 3 is a block diagram illustrating an example of a configuration of a terminal device according to the embodiment.

FIG. 4 is a schematic functional block diagram illustrating an example of a configuration of a radar device according to a comparative example.

FIG. 5 is an explanatory diagram for describing an outline of an example of an object detection mechanism using a chirp signal.

FIG. 6 is a block diagram illustrating an example of a schematic configuration of a signal generation section that generates a signal used for object detection.

FIG. 7 is a block diagram illustrating an example of a schematic configuration of a portion related to reception of reflected waves obtained by reflection of a transmission signal from a target.

FIG. 8 is a block diagram illustrating an example of a schematic configuration of a signal processing section that performs processing related to detection of an object according to a result of reception of reflected waves obtained by reflection of a transmission signal from the object.

FIG. 9 is an explanatory diagram for describing an outline of the influence of interference of other wireless signals on a radar.

FIG. 10 is an explanatory diagram for describing an outline of the influence of interference of other wireless signals on a radar.

FIG. 11 is an explanatory diagram for describing an example of a method for reducing the influence of interference between radars.

FIG. 12 is an explanatory diagram for describing an example of a transmission timing of a wireless signal related to object detection by the radar device according to the embodiment.

FIG. 13 is an explanatory diagram for describing another example of the transmission timing of the wireless signal related to object detection by the radar device according to the embodiment.

FIG. 14 is an explanatory diagram for describing an outline of a technology capable of further reducing the influence of interference between radar devices in the system according to the embodiment.

FIG. 15 is an explanatory diagram for describing an example of a resource allocation method according to a usage condition of the radar device.

FIG. 16 is an explanatory diagram for describing another example of the resource allocation method according to the usage condition of the radar device.

FIG. 17 is an explanatory diagram for describing another example of the resource allocation method according to the usage condition of the radar device.

FIG. 18 is a block diagram illustrating an example of a functional configuration of the radar device according to the embodiment.

FIG. 19 is an explanatory diagram for describing an example of a configuration of the system according to the embodiment.

FIG. 20 is a sequence diagram illustrating an example of a flow of a series of processing of a system according to Example 1.

FIG. 21 is a sequence diagram illustrating an example of a flow of a series of processing of a system according to Example 2.

FIG. 22 is a sequence diagram illustrating an example of a flow of a series of processing of a system according to Example 3.

FIG. 23 is a sequence diagram illustrating an example of a flow of a series of processing of the system according to Example 3.

FIG. 24 is a block diagram illustrating a first example of a schematic configuration of an eNB.

FIG. 25 is a block diagram illustrating a second example of the schematic configuration of the eNB.

FIG. 26 is a block diagram illustrating an example of a schematic configuration of a smartphone.

FIG. 27 is a block diagram illustrating an example of a schematic configuration of a car navigation device.

### MODE FOR CARRYING OUT THE INVENTION

Hereinafter, preferred embodiments of the present disclosure will be described in detail with reference to the accompanying drawings. Note that in the present specification and the drawings, constituent elements having substantially the same functional configuration will be denoted by the same reference numerals, and redundant description will be omitted.

Note that descriptions will be provided in the following order.

1. Example of Configuration

1.1. Example of System Configuration

1.2. Example of Configuration of Base Station

1.3. Example of Configuration of Terminal Device

2. In-vehicle Radar

3. Examination of Influence of Wireless Signal Interference on Radar

4. Technical Advantages

4.1. Technology Related to Reduction of Interference

4.2. Technology that Enables Efficient Use of Resources

4.3. Example of Configuration and Processing Related to Control of Operation of Radar Device

5. Application Example

6. Conclusion

### 1. EXAMPLE OF CONFIGURATION

<1.1. Example of System Configuration>

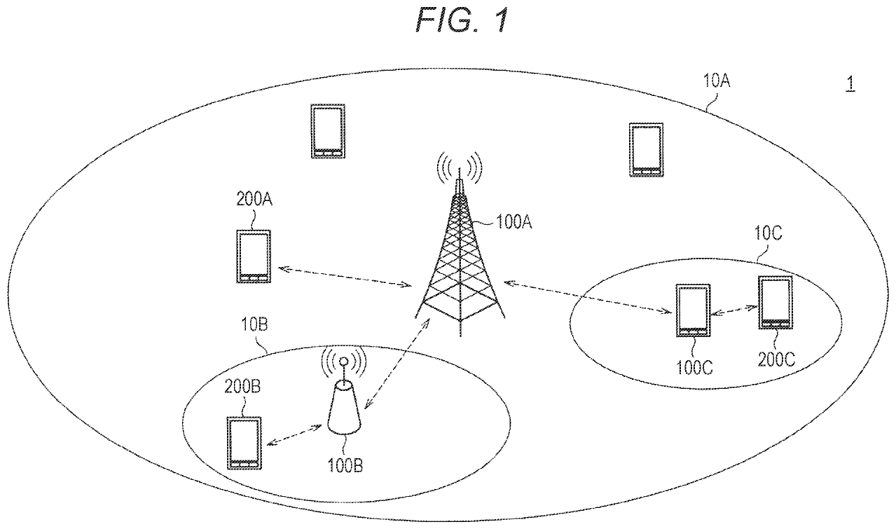

First, an example of a schematic configuration of a system 1 according to an embodiment of the present disclosure will be described with reference to FIG. 1. FIG. 1 is an explanatory diagram for describing an example of the schematic configuration of the system 1 according to an embodiment of the present disclosure. As illustrated in FIG. 1, the system 1 includes a wireless communication device 100 and a terminal device 200. Here, the terminal device 200 is also referred to as a user. The user may also be referred to as a UE. A wireless communication device 100C is also referred to as a UE-relay. Here, the UE may be a UE defined in LTE or LTE-A, and the UE-relay may be a Prose UE-to-Network relay being discussed in 3GPP, or may more generally mean a communication apparatus.

(1) Wireless Communication Device 100

The wireless communication device 100 is a device that provides a wireless communication service to a subordinate device. For example, a wireless communication device 100A is a base station of a cellular system (or mobile communication system). The base station 100A performs wireless communication with a device (for example, a terminal device 200A) located inside a cell 10A of the base station 100A. For example, the base station 100A transmits a downlink signal to the terminal device 200A and receives an uplink signal from the terminal device 200A.

The base station 100A is logically connected to another base station by, for example, an X2 interface, and can transmit and receive control information and the like. Further, the base station 100A is logically connected to a so-called core network (not illustrated) by, for example, an S1 interface, and can transmit and receive control information and the like. Note that communication between these devices can be physically relayed by various devices.

Here, the wireless communication device 100A illustrated in FIG. 1 is a macrocell base station, and the cell 10A is a macrocell. On the other hand, wireless communication devices 100B and 100C are master devices that operate small cells 10B and 10C, respectively. As an example, the master device 100B is a fixedly installed small cell base station. The small cell base station 100B establishes a wireless backhaul link with the macrocell base station 100A and establishes an access link with one or more terminal devices (for example, the terminal device 200B) within the small cell 10B. Note that the wireless communication device 100B may be a relay node defined in 3GPP. The master device 100C is a dynamic access point (AP). The dynamic AP 100C is a mobile device that dynamically operates the small cell 10C. The dynamic AP 100C establishes a wireless backhaul link with the macrocell base station 100A and establishes an access link with one or more terminal devices (for example, the terminal device 200C) within the small cell 10C. The dynamic AP 100C may be, for example, a terminal device mounted with hardware or software capable of being operated as a base station or a wireless access point. The small cell 10C in this case is a localized network/virtual cell that is dynamically formed.

The cell 10A can be operated according to any wireless communication scheme such as LTE, LTE-advanced (LTE-A), LTE-Advanced Pro, GSM (registered trademark), UMTS, W-CDMA, CDMA2000, WiMAX, WiMAX2, IEEE 802.16, or the like.

Note that the small cell is a concept that can include various types of cells (for example, a femtocell, a nanocell, a picocell, a microcell, and the like) that are smaller than the macrocell and are arranged so as to overlap or so as not to overlap with the macrocell. In one example, the small cell is operated by a dedicated base station. In another example, the small cell is operated by temporarily operating a terminal, that serves as the master device, as a small cell base station. A so-called relay node can also be regarded as a form of the small cell base station. A wireless communication device that functions as a master station of the relay node is also referred to as a donor base station. The donor base station may mean a DeNB in LTE, or may more generally mean the master station of the relay node.

(2) Terminal Device 200

The terminal device 200 can perform communication in a cellular system (or mobile communication system). The terminal device 200 performs wireless communication with a wireless communication device (for example, the base station 100A or the master device 100B or 100C) of the cellular system. For example, the terminal device 200A receives a downlink signal from the base station 100A and transmits an uplink signal to the base station 100A.

Furthermore, the terminal device 200 is not limited to the so-called UE, and for example, a so-called low cost terminal (low cost UE) such as an MTC terminal, an enhanced MTC (eMTC) terminal, an NB-IoT terminal, or the like may be applied. Furthermore, an infrastructure terminal such as a road side unit (RSU) or a terminal such as customer premises equipment (CPE) may be applied.

(3) Supplement

Although the schematic configuration of the system 1 has been described above, the present technology is not limited to the example illustrated in FIG. 1. For example, as the configuration of the system 1, a configuration including no master device, small cell enhancement (SCE), a heterogeneous network (HetNet), a MTC network, or the like can be adopted. Furthermore, as another example of the configuration of the system 1, a master device may be connected to a small cell such that a cell is constructed under the small cell.

<1.2. Example of Configuration of Base Station>

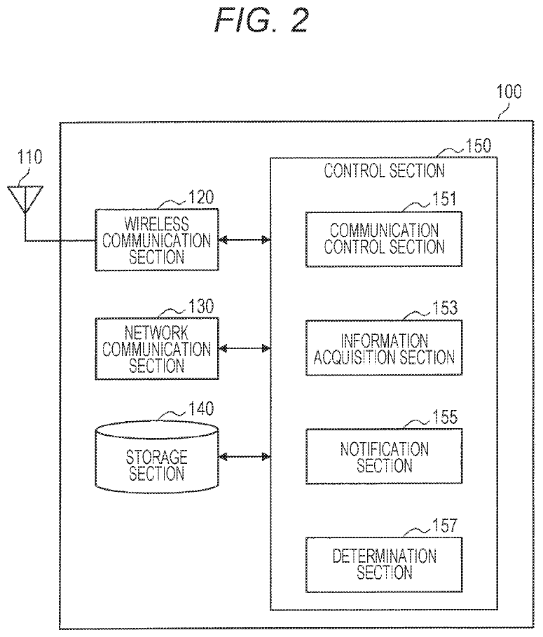

Next, a configuration of the base station 100 according to an embodiment of the present disclosure will be described with reference to FIG. 2. FIG. 2 is a block diagram illustrating an example of the configuration of the base station 100 according to an embodiment of the present disclosure. Referring to FIG. 2, the base station 100 includes an antenna section 110, a wireless communication section 120, a network communication section 130, a storage section 140, and a control section 150.

(1) Antenna Section 110

The antenna section 110 radiates a signal output from the wireless communication section 120 as radio waves in the air. Furthermore, the antenna section 110 converts radio waves in the air into a signal and outputs the signal to the wireless communication section 120.

(2) Wireless Communication Section 120

The wireless communication section 120 transmits and receives a signal. For example, the wireless communication section 120 transmits a downlink signal to a terminal device and receives an uplink signal from a terminal device.

(3) Network Communication Section 130

The network communication section 130 transmits and receives information. For example, the network communication section 130 transmits information to another node and receives information from another node. Examples of the another node described above include other base stations and core network nodes.

Note that, as described above, in the system 1 according to the present embodiment, a terminal device may be operated as a relay terminal and relay communication between a remote terminal and a base station. In such a case, for example, the wireless communication device 100C corresponding to the relay terminal does not have to include the network communication section 130.

(4) Storage Section 140

The storage section 140 temporarily or permanently stores a program and various data for the operation of the base station 100.

(5) Control Section 150

The control section 150 provides various functions of the base station 100. The control section 150 includes a communication control section 151, an information acquisition section 153, a notification section 155, and a determination section 157. Note that the control section 150 can further include other constituent elements other than these constituent elements. That is, the control section 150 can perform operations other than the operations of these constituent elements.

The communication control section 151 performs various processing related to a control of wireless communication with the terminal device 200 via the wireless communication section 120. For example, the communication control section 151 may allocate a wireless resource (hereinafter, also simply referred to as a “resource”) that can be used by the terminal device 200 for transmitting a wireless signal. As a specific example, in a case where the terminal device 200 is configured as a mobile object such as a vehicle or the like, the communication control section 151 may allocate a resource that can be used for transmission of a wireless signal used by a radar (for example, an in-vehicle radar) included in the mobile object to detect an object.

Furthermore, as another example, the communication control section 151 may perform various controls for further reducing the influence of wireless signal interference between the terminal devices 200. As a specific example, in a case where the terminal device 200 is configured as a mobile object such as a vehicle or the like, the communication control section 151 may control a transmission timing of a wireless signal used by a radar included in the mobile object to detect an object.

Furthermore, the communication control section 151 performs various processing related to a control of communication with another node (for example, another base station, a core network node, or the like) via the network communication section 130.

The information acquisition section 153 acquires various information from the terminal device 200 or another node. For example, the information acquisition section 153 may acquire, from the terminal device 200, information regarding a desire for allocation of the resource described above, a desire for allocation of the transmission timing described above, and the like. The acquired various information may be used, for example, for controlling various operations of the terminal device 200. In addition, the information acquisition section 153 may acquire various information collected by the terminal device 200 from at least some of the terminal devices 200. As a specific example, the information acquisition section 153 may acquire, from a terminal device 200, information according to a result of monitoring the surrounding environment of the terminal device 200.

The notification section 155 notifies the terminal device 200 or another node of various information. For example, the notification section 155 may notify the terminal device of information regarding the allocated resource described above or information regarding the allocated transmission timing described above.

The determination section 157 performs processing related to various types of determination. For example, the determination section 157 may make a predetermined determination on the basis of the information acquired by the information acquisition section 153. As a specific example, the determination section 157 may select a terminal device 200, to which a part of the role of the base station 100 is to be delegated, among terminal devices 200 in a cell according to various information transmitted from the terminal device 200. Note that the determination section 157 in this case corresponds to an example of a “selection section”.

<1.3. Example of Configuration of Terminal Device>

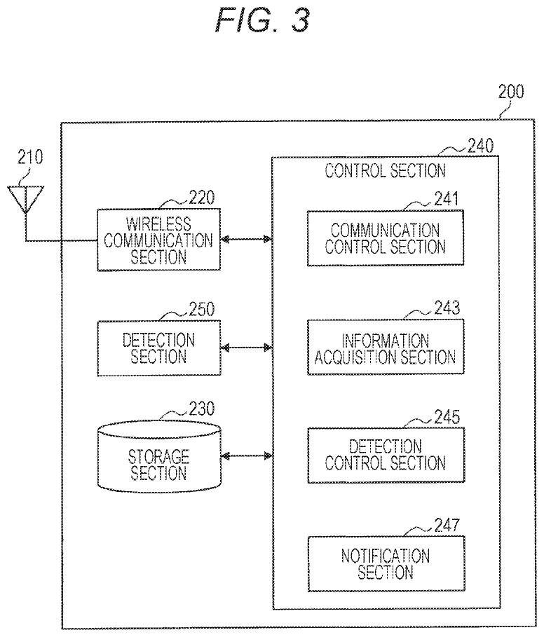

Next, an example of a configuration of the terminal device 200 according to the embodiment of the present disclosure will be described with reference to FIG. 3. FIG. 3 is a block diagram illustrating an example of the configuration of the terminal device 200 according to the embodiment of the present disclosure. As illustrated in FIG. 3, the terminal device 200 includes an antenna section 210, a wireless communication section 220, a storage section 230, a control section 240, and a detection section 250.

(1) Antenna Section 210

The antenna section 210 radiates a signal output from the wireless communication section 220 as radio waves in the air. Furthermore, the antenna section 210 converts radio waves in the air into a signal and outputs the signal to the wireless communication section 220.

(2) Wireless Communication Section 220

The wireless communication section 220 transmits and receives a signal. For example, the wireless communication section 220 receives a downlink signal from a base station and transmits an uplink signal to a base station.

Furthermore, in the system 1 according to the present embodiment, the terminal device 200 may perform direct communication with another terminal device 200 without going through the base station 100. In this case, the wireless communication section 220 may transmit and receive a sidelink signal to and from another terminal device 200.

(3) Storage Section 230

The storage section 230 temporarily or permanently stores a program and various data for the operation of the terminal device 200.

(4) Detection Section 250

The detection section 250 schematically shows a configuration related to object detection. For example, the detection section 250 transmits a wireless signal and detects a distance to an object, a speed of the object, a direction (azimuth) in which the object is located, and the like by using a result of reception of reflected waves from the object and the like. Note that the details of the configuration of the detection section 250 will be described later.

(5) Control Section 240

The control section 240 provides various functions of the terminal device 200. For example, the control section 240 includes a communication control section 241, an information acquisition section 243, a detection control section 245, and a notification section 247. Note that the control section 240 can further include other constituent elements other than these constituent elements. That is, the control section 240 can perform operations other than the operations of these constituent elements.

The communication control section 241 performs various processing related to a control of wireless communication with the base station 100 or another terminal device 200 via the wireless communication section 220. For example, the communication control section 241 may select some of resources reserved by the base station 100 and perform a control so that a packet is transmitted using the selected resource.

The information acquisition section 243 acquires various information from the base station 100 and another terminal device 200. As a specific example, the information acquisition section 243 may acquire, from the base station 100 or another terminal device 200, information regarding a control of the operation of the detection section 250 (in other words, information regarding object detection). As a more specific example, the information acquisition section 243 may acquire, from the base station 100 and another terminal device 200, information regarding a resource available for transmission of a wireless signal related to object detection, information regarding a transmission timing of the wireless signal, and the like.

The detection control section 245 controls an operation related to object detection by the detection section 250. As a specific example, the detection control section 245 may control an operation related to the transmission of the wireless signal described above by the detection section 250, an operation related to reception of reflected waves obtained by reflection of the wireless signal from the object, and the like.

The notification section 247 notifies the base station 100 or another terminal device 200 of various information. As a specific example, the notification section 247 may notify a base station or another terminal device 200 of a request related to transmission of various information (for example, information regarding a resource or transmission timing, or the like) for the detection control section 245 described above to control an operation related to detection of an object by the detection section 250.

### 2. IN-VEHICLE RADAR

Next, an outline of an in-vehicle radar will be described. An in-vehicle radar is one of the important elemental technologies for realizing driving support and automatic driving of mobile objects such as automobiles and the like. The in-vehicle radar is one of the key devices in an in-vehicle sensing technology, along with cameras and lidar that are intended for in-vehicle use.

Furthermore, in recent years, the use of a wireless signal having a frequency of 76 GHz to 77 GHz or 77 GHz to 81 GHz has been studied for such an in-vehicle radar, the wireless signal being called millimeter waves (hereinafter, also simply referred to as “millimeter waves”). A radar using millimeter waves (hereinafter, also referred to as a “millimeter wave radar”) can miniaturize an antenna due to a short wavelength of a millimeter wave signal. In addition, with the miniaturization of an antenna, it is possible to realize the array antenna more easily than before. For example, it is possible to realize a high-gain array antenna with a more realistic size by using a plurality of the antennas. Therefore, the millimeter wave radar has become of interest for applications in the in-vehicle radar. As a specific example, by utilizing the above-described characteristics, for example, a mid-range radar (MRR), a long-range radar (LRR), or the like that senses a distant target can be put into practical use.

Further, in a millimeter wave band, it is possible to use a wider frequency band than a frequency band used for conventional wireless communication. Therefore, by utilizing such characteristics, for example, it is possible to further improve distance decomposition performance, and it is also possible to realize a higher performance short range radar (SRR).

As the millimeter wave band used for a radar, for example, a band of 76 GHz to 77 GHz, a band of 77 GHz to 81 GHz, and the like are known. Note that there may be restrictions on the use of these bands depending on the country or region. For example, in Japan, restrictions on the use are set for the band of 76 GHz so that the frequency band is 1 GHz or less, the antenna power is 10 mW or less, and the antenna gain is 40 dBi or less. Similarly, restrictions on the use are set for the band of 79 GHz so that the frequency band is 4 GHz or less, the antenna power is 10 mW or less, and the antenna gain is 35 dBi or less.

(Example of Configuration of Radar Device)

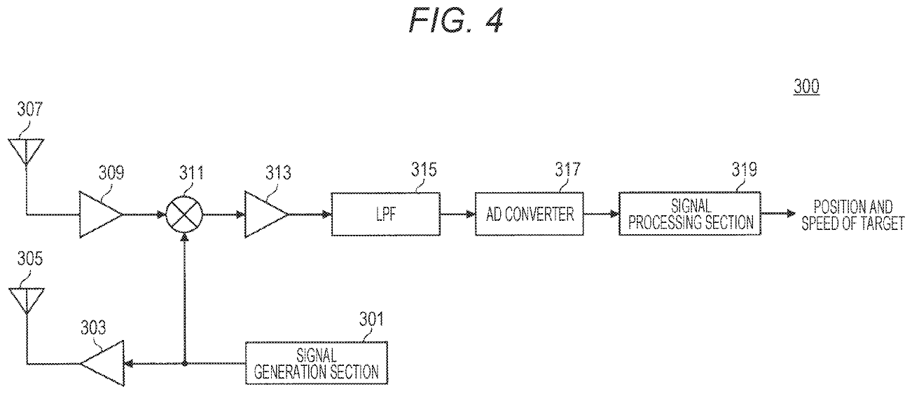

Here, as a comparative example, an example of a configuration of a typical radar device that can be applied as an in-vehicle radar will be described. For example, FIG. 4 is a schematic functional block diagram illustrating an example of a configuration of a radar device according to a comparative example, and illustrates an example of a configuration of a radar device that transmits a wireless signal and detects an object by using a result of reception of reflected waves obtained by reflection of the wireless signal from the object.

As illustrated in FIG. 4, a radar device 300 includes a signal generation section 301, amplifiers 303, 309, and 313, a transmitting antenna 305, a receiving antenna 307, a mixer 311, a low-pass filter (LPF) 315, an AD converter 317, and a signal processing section 319.

The signal generation section 301 generates an electric signal for driving the transmitting antenna in order to transmit a wireless signal used for detecting an object. In a radar applied as an in-vehicle radar, generally, a wireless signal whose frequency is controlled to continuously change in time series, such as a so-called chirp signal, is used. Note that, in the following description, for convenience, a case where a chirp signal is used for object detection will be described. That is, the signal generation section 301 generates and outputs a chirp signal. Note that the chirp signal (electric signal) output from the signal generation section 301 is split by a splitter and the like, and some signals are amplified by the amplifier 303 and then transmitted to the outside as wireless signals from the transmitting antenna 305. Further, other signals that are split from the chirp signal output from the signal generation section 301 are supplied to the mixer 311.

Reflected waves obtained by reflection of a wireless signal (chirp signal) transmitted from the transmitting antenna 305 from an object are received by the receiving antenna 307. That is, an electric signal according to a result of reception of the reflected waves by the receiving antenna 307 is amplified by the amplifier 309 and then supplied to the mixer 311. As the amplifier 309, for example, it is more desirable that a low-noise amplifier is applied.

The mixer 311 multiplies the above-described electric signal (chirp signal) output from the signal generation section 301 by the electric signal according to the result of the reception of the above-described reflected waves by the receiving antenna 307, and outputs an electric signal according to a result of the multiplication to the amplifier 313 positioned at the subsequent stage. Note that, a beat signal is obtained as the result of the above-described multiplication by the mixer 311, the beat signal being a difference frequency component between two signals input to the mixer 311.

The electric signal (that is, the beat signal) according to the result of the above-described multiplication by the mixer 311 is subjected to removal of unnecessary noise components (for example, high frequency components and the like) by the LPF 315 after being amplified by the amplifier 313, and is AD-converted from an analog electric signal into a digital electric signal by the AD converter 317. Then, the digital electric signal according to the result of the AD conversion is output from the AD converter 317 to the signal processing section 319.

The signal processing section 319 performs various signal analyses on the electric signal obtained by AD-converting the result (beat signal) of the multiplication of the electric signal output from the AD converter 317, that is, the chirp signal output from the signal generation section 301, and the electric signal according to the result of reception of the reflected waves described above. Then, the signal processing section 319 detects an object on the basis of a result of the signal analysis. Specifically, the signal processing section 319 calculates a distance to the object, a speed of the object, a direction (azimuth) in which the object is located, and the like on the basis of the result of the signal analysis. Note that a result of the detection of the object by the signal processing section 319 is used for, for example, a control of a mobile object such as a vehicle or the like (for example, driving support, automatic driving, or the like).

(Object Detection Mechanism)

Next, an outline of an example of an object detection mechanism using a chirp signal will be described.

As described above, the chirp signal is controlled so that the frequency changes continuously in time series. Here, a frequency sweeping method for the chirp signal may be various according to a combination a slope of the frequency change in time series, an interval, a pattern of the frequency change, and the like. Generally, in the millimeter-wave radar applied as the in-vehicle radar, a frequency modulated continuous wave (FMCW) method, a fast chirp modulation (FCM) method, or the like is widely used as the frequency sweeping method for the chirp signal. Especially in recent years, the FCM method has become more important than the FMCW method, and is widely adopted by a high-performance in-vehicle radar.

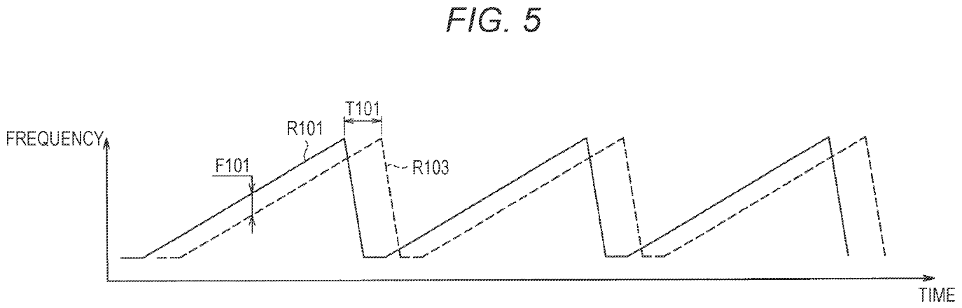

For example, FIG. 5 is an explanatory diagram for describing an outline of an example of an object detection mechanism using a chirp signal, and illustrates an example of a typical chirp signal used in the FCM method. In FIG. 5, the horizontal axis represents time and the vertical axis represents frequency. Furthermore, in FIG. 5, a reference signal R101 indicates a chirp signal (hereinafter, also referred to as a “transmission signal” for convenience) transmitted as a wireless signal. Further, Reference Numeral R103 indicates a signal (hereinafter, also referred to as a “reception signal” for convenience) according to a result of reception of reflected waves obtained by reflection of the transmitted wireless signal from an object.

In the FCM method, for example, the frequency is linearly changed from a low frequency to a high frequency (up-chirp), and a signal (wireless signal) subjected to such frequency control is periodically transmitted. As a chirp pulse sweep time width of such an up-chirp signal, for example, a time width of about 10 μs to 100 μs can be assumed. In the FCM method, it is possible to improve temporal resolution of the radar by periodically and repeatedly transmitting a chirp signal having such a short pulse width. That is, the FCM method has a relatively high accuracy in measuring a speed of a target (object), and it is possible to realize a high-performance (high resolution) radar by applying this method.

Next, the principle of radar ranging will be outlined by taking the case of the FCM method as an example with reference to FIG. 5. A transmission signal (chirp signal) transmitted from a transmitter of a radar hits a target (object or the like), and reflected waves resulting therefrom are received as a reception signal by a receiver of the radar. Here, ranging (that is, measurement of a distance to the target) is possible by measuring a time for the wireless signal, which is electromagnetic waves transmitted from the radar, to reciprocate between the radar and the target. Specifically, in the example illustrated in FIG. 5, the radar detects a frequency difference between the transmission signal and the reception signal, and calculates the distance to the target according to the frequency difference.

For example, in FIG. 5, Reference Numeral R101 schematically indicates the transmission signal. Further, Reference Numeral R103 schematically indicates the reception signal (reflected waves). Further, Reference Numeral T101 schematically indicates a delay between the transmission signal and the reception signal. Further, Reference Numeral F101 schematically indicates a beat frequency between the transmission signal and the reception signal.

Here, m represents a frequency change of the chirp signal per unit time (a slope of a graph of the transmission signal R101), c represents the speed of light, and f represents a frequency of the detected beat signal (that is, a beat frequency). Here, a distance x between the radar and the target is expressed by the following formula shown as (Equation 1).

$$[ Math . 1 ]$$

$$x = \frac{cf}{2 m} \qquad ( Equation 1 )$$

Furthermore, in a radar adopting the FCM method, it is possible to detect a relative speed between a device mounted with the radar (for example, a mobile object such as a vehicle or the like) and a target by detecting a phase difference of a plurality of chirp signals. Information according to a result of such speed detection is useful information for realizing, for example, an in-vehicle sensing technology.

(Example of Configuration of Signal Generation Section)

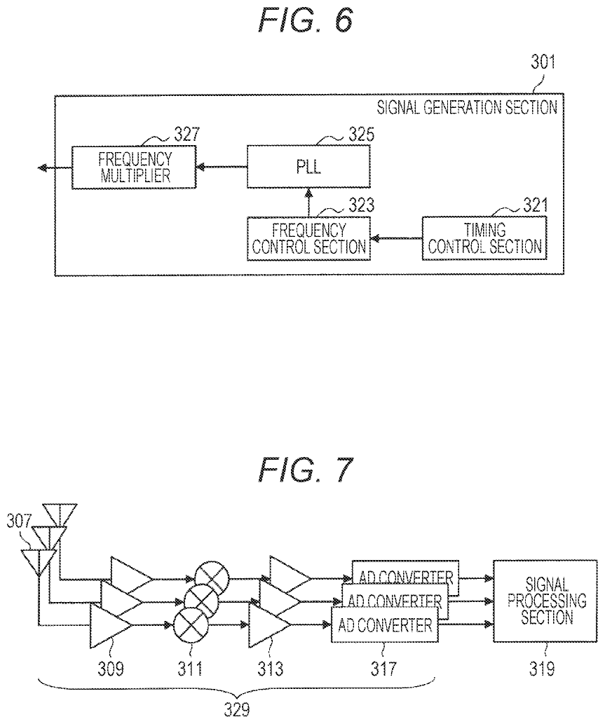

Next, as an example of a configuration of the signal generation section 301 illustrated in FIG. 4, an example of a configuration related to generation of a signal used for object detection, particularly, a case where a signal (for example, chirp signal) controlled so that the frequency continuously changes in time series is generated, will be described. For example, FIG. 6 is a block diagram illustrating an example of a schematic configuration of the signal generation section that generates a signal used for object detection. Note that, in the following, for convenience, a case where the signal generation section 301 illustrated in FIG. 6 generates a chirp signal will be described.

As illustrated in FIG. 6, the signal generation section 301 includes a timing control section 321, a frequency control section 323, a phase locked loop (PLL) 325, and a frequency multiplier 327.

The PLL 325 generates a signal that is the basis of the chirp signal output from the signal generation section 301. Specifically, the PLL 325 generates a signal (chirp signal) whose frequency continuously changes in time series according to a control by the frequency control section 323 as described later, and outputs the signal to the frequency multiplier 327. Therefore, the PLL 325 may include, for example, an oscillator configured to be able to control the frequency. It is a matter of course that as long as the PLL 325 can generate a signal having a desired frequency, a configuration for that purpose is not particularly limited.

The frequency multiplier 327 takes the signal generated by the PLL 325 as an input, generates a signal having a frequency that is an integral multiple of that of the signal, and outputs the signal. In general, it is difficult to directly oscillate so-called high frequency waves such as a signal in a millimeter-wave band (particularly, to perform sending at a more accurate frequency). Therefore, in the signal generation section 301 illustrated in FIG. 6, high frequency waves such as millimeter waves are generated and output through multiplication of the signal generated by the PLL 325 by the frequency multiplier 327. Note that since a commonly used frequency multiplier can be used as the frequency multiplier 327, a detailed description of the configuration of the frequency multiplier 327 itself will be omitted.

The timing control section 321 generates a timing signal that serves as a reference for a time series control, and outputs the timing signal to the frequency control section 323. As a specific example, the timing control section 321 may generate a reference clock as the timing signal described above and supply the reference clock to the frequency control section 323. Therefore, the frequency control section 323 can perform various processing in synchronization with a desired timing based on the reference clock by measuring a time according to the reference clock supplied from the timing control section 321. Of course, the above description is only an example, and as long as the frequency control section 323 can perform various operations at a desired timing, a method related to a control of the timing by the timing control section 321 is not particularly limited.

The frequency control section 323 controls an operation related to the signal generation by the PLL 325. Specifically, the frequency control section 323 may control the operation of the PLL 325 so that a frequency of the signal output from the PLL 325 continuously changes in time series on the basis of the timing signal output from the timing control section 321. Furthermore, the frequency control section 323 may control the frequency of the signal output from the PLL 325 on the assumption that the signal output from the PLL 325 is multiplied by the frequency multiplier 327 and output to the outside. That is, in this case, the frequency control section 323 may control the operation related to the signal generation (oscillation) by the PLL 325 so that, for example, the signal oscillates at a frequency that is an integral submultiple of the signal output from the signal generation section 301 to the outside.

As described above, a signal (electric signal) controlled so that the frequency continuously changes in time series is generated, and the signal is output to outside (for example, the amplifier 303, the mixer 311, or the like illustrated in FIG. 4) of the signal generation section 301.

(Example of Configuration of Receiving Circuit)

Next, an example of a configuration of a portion (a so-called portion corresponding to the receiving circuit) related to reception of reflected waves obtained by reflection of a transmission signal (for example, chirp waves) transmitted from the transmitting antenna from a target will be described. FIG. 7 is a block diagram illustrating an example of a schematic configuration of a portion related to reception of reflected waves obtained by reflection of a transmission signal from a target.

The example illustrated in FIG. 7 illustrates an example of a case where a plurality of portions related to reception of reflected waves obtained by reflection of a transmission signal from a target is provided. Specifically, in the example illustrated in FIG. 7, a series of a plurality of components (hereinafter, also referred to as a “receiving unit 329” for convenience) including the receiving antenna 307, the amplifier 309, the mixer 311, the amplifier 313, and the AD converter 317 and indicated by Reference Numeral 321 is provided. Note that the LPF 315 may be provided in each receiving unit 329 so that the LPF 315 is interposed between the amplifier 313 and the AD converter 317, similarly to the example illustrated in FIG. 4.

On the basis of such a configuration, the signal processing section 319 uses a result of reception by each receiving unit 329 to detect a target (object). Note that the components of the portion related to generation and transmission of a transmission signal, that is, the signal generation section 301, the amplifier 303, and the transmitting antenna 305 illustrated in FIG. 4 are not illustrated in the example illustrated in FIG. 7. Therefore, although explicit illustration is omitted in FIG. 7, a transmission signal (that is, a signal generated by the signal generation section 301) is input to the mixer 311 of each receiving unit 329, in addition to a signal output from the amplifier 309 of the receiving unit 329 (that is, a signal according to a result of reception of reflected waves by the receiving antenna 307).

With such a configuration, in the example illustrated in FIG. 7, the receiving antennas 307 of the respective receiving units 329 can be arranged at positions spatially separate from each other. Therefore, for example, it is possible to calculate an azimuth (that is, an azimuth of a target reflecting a transmission signal) of a transmission source of a reception signal by taking a signal according to a result of reception by each receiving antenna 307 as an input and using a technology which is so-called beamforming.

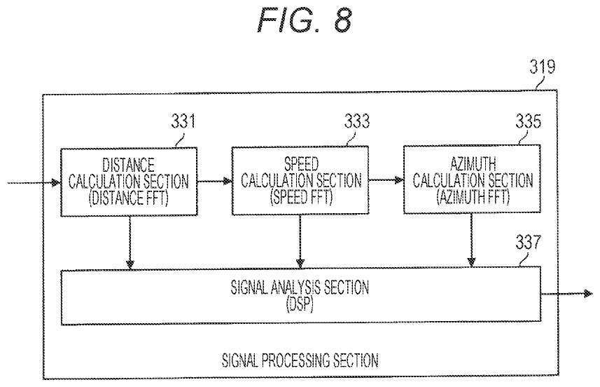

Here, an example of a functional configuration of the signal processing section 319 will be described with reference to FIG. 8. FIG. 8 is a block diagram illustrating an example of a schematic configuration of the signal processing section that performs processing related to detection of an object according to a result of reception of reflected waves obtained by reflection of a transmission signal from the object. Note that the example illustrated in FIG. 8 illustrates an example of a configuration of the signal processing section 319 in a case where, for example, a plurality of receiving units 329 is provided as in the example illustrated in FIG. 7 to calculate an azimuth of a target, in addition to a distance to the target and a speed of the target. That is, FIG. 8 illustrates an example of the configuration of the signal processing section 319, assuming the use of a digital beamforming technology for receiving reflected waves obtained by reflection of a transmission signal from an object.

As illustrated in FIG. 8, the signal processing section 319 includes a distance calculation section 331, a speed calculation section 333, an azimuth calculation section 335, and a signal analysis section 337.

The distance calculation section 331 performs calculation processing related to distance calculation for a signal input to the signal processing section 319, that is, a digital beat signal. As a specific example, the distance calculation section 331 performs a distance fast Fourier transform (FFT) as signal processing for the input beat signal, and outputs information according to a result thereof to the signal analysis section 337.

The speed calculation section 333 performs calculation processing related to speed calculation for a signal input to the signal processing section 319, that is, a digital beat signal. As a specific example, the speed calculation section 333 performs a speed FFT as signal processing for the input beat signal, and outputs information according to a result thereof to the signal analysis section 337.

The azimuth calculation section 335 performs calculation processing related to azimuth calculation for a signal input to the signal processing section 319, that is, a digital beat signal. As a specific example, the azimuth calculation section 335 performs processing related to phase difference detection by the FFT as signal processing for a reception signal according to a result of reception by each of the plurality of receiving antennas 307, and outputs information according to a result thereof to the signal analysis section 337.

The signal analysis section 337 detects a target according to a result of various calculation processing (in other words, various signal processing) for the signal input to the signal processing section 319 described above. Specifically, the signal analysis section 337 acquires information regarding a distance to a target on the basis of the information according to the result of the distance FFT for the above-described signal by the distance calculation section 331. Furthermore, the signal analysis section 337 acquires information regarding a distance to a target on the basis of the information according to the result of the speed FFT for the above-described signal by the speed calculation section 333. Furthermore, the signal analysis section 337 acquires information regarding a direction (azimuth) in which the target is located on the basis of the information according to the result of the processing related to the phase difference detection by the FFT for the above-described signal by the azimuth calculation section 335. Then, the signal analysis section 337 outputs the acquired various information described above to a predetermined output destination. Note that the signal analysis section 337 may be configured with, for example, a digital signal processor (DSP).

As described above, it is possible to acquire information regarding the distance to the target, the speed of the target, the azimuth of the target, and the like. With such a configuration, for example, by acquiring the above-described information of another mobile object or the like as a target, it is possible to use the acquired information as information for realizing driving support or automatic driving of a mobile object such as a vehicle or the like. Note that, in a case where any of the distance to the target, the speed of the target, or the azimuth of the target is not to be detected, among the distance calculation section 331, the speed calculation section 333, and the azimuth calculation section 335, a component corresponding to the parameter that is not to be detected does not have to be included.

Hereinabove, the outline of the in-vehicle radar has been described with reference to FIGS. 4 to 8.

### 3. EXAMINATION OF INFLUENCE OF WIRELESS SIGNAL INTERFERENCE ON RADAR

Next, the influence of interference of another wireless signal on the radar that detects a target according to a result of reception of reflected waves obtained by reflection of a transmission signal from the target as described above will be examined and then a technical problem of the radar device according to an embodiment of the present disclosure will be described.

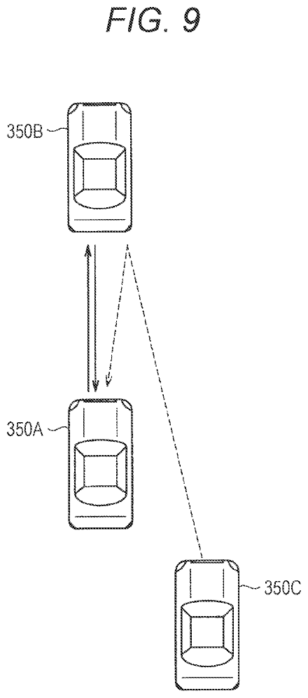

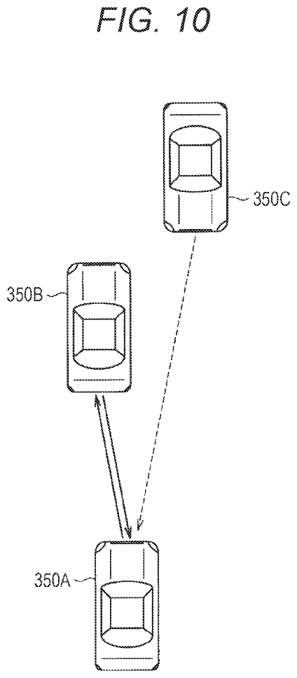

A wireless signal other than reflected waves of a transmission signal transmitted from an in-vehicle radar may be mixed in a receiving circuit of the in-vehicle radar, and a result of reception of the wireless signal may interfere with a result of reception of the reflected waves, which results in deterioration in performance related to target detection. For example, FIGS. 9 and 10 are each an explanatory diagram for describing an overview of the influence of interference of another wireless signal on the radar.

Specifically, FIG. 9 illustrates an example of a case where a result of reception of reflected waves by an in-vehicle radar is interfered with a wireless signal (transmission signal) transmitted from another in-vehicle radar. More specifically, the example illustrated in FIG. 9 illustrates a situation where an in-vehicle radar of a vehicle 350A transmits a wireless signal forward and receives reflected waves resulting therefrom to detect a vehicle 350B located in front of the vehicle 350A. Furthermore, in the example illustrated in FIG. 9, an in-vehicle radar of a vehicle 350C located diagonally behind the vehicle 350A also transmits a wireless signal in order to detect another vehicle. At this time, the wireless signal transmitted from the in-vehicle radar of the vehicle 350C is reflected from the vehicle 350B, and reflected waves resulting therefrom is received by the in-vehicle radar of the vehicle 350A, which may interfere with processing related to the detection of the vehicle 350B by the in-vehicle radar of the vehicle 350A. In this case, for example, the in-vehicle radar of the vehicle 350A may receive the reflected waves of the transmission signal from the in-vehicle radar of the vehicle 350C at a timing different from a timing of receiving the reflected waves of its own transmission signal. That is, there is a possibility that an image (that is, a virtual image) of a target that is originally not supposed to exist is generated in a detection result of the in-vehicle radar of the vehicle 350A.

Further, FIG. 10 illustrates another example of the case where a result of reception of reflected waves by an in-vehicle radar is interfered with a wireless signal (transmission signal) transmitted from another in-vehicle radar. More specifically, the example illustrated in FIG. 10 illustrates a situation where an in-vehicle radar of a vehicle 350A transmits a wireless signal forward and receives reflected waves resulting therefrom to detect a vehicle 350B located in front of the vehicle 350A. Furthermore, in the example illustrated in FIG. 10, an in-vehicle radar of a vehicle 350C (oncoming vehicle) located diagonally in front of the vehicle 350A also transmits a wireless signal in order to detect another vehicle. At this time, the wireless signal transmitted from the in-vehicle radar of the vehicle 350C is directly received by the in-vehicle radar of the vehicle 350A, which may interfere with processing related to the detection of the vehicle 350B by the in-vehicle radar of the vehicle 350A. Also in this case, for example, the in-vehicle radar of the vehicle 350A may receive the transmission signal from the in-vehicle radar of the vehicle 350C at a timing different from a timing of receiving the reflected waves of its own transmission signal. That is, there is a possibility that an image (that is, a virtual image) of a target that is originally not supposed to exist is generated in a detection result of the in-vehicle radar of the vehicle 350A.

At present, the in-vehicle radar is in the stage of commercialization, and some vehicles perform transmission of a wireless signal (for example, a wireless signal in a millimeter-wave band) for detecting another vehicle and the like. However, at this stage, each company uses a different method for transmitting the wireless signal. That is, each vehicle senses another vehicle and the like by transmitting a wireless signal (for example, millimeter waves) with a signal intensity of a starting point at an arbitrary timing.

However, as described above, each vehicle randomly transmits a wireless signal (hereinafter, also referred to as “radar waves”) for detecting a target such as another vehicle and the like, and thus there is a possibility of causing an unintended interference with the in-vehicle radar of another vehicle as described above. That is, in the in-vehicle radar of the vehicle that has undergone interference, there is a possibility that an unintended deterioration in performance such as an appearance of a virtual image in a target detection result, or the like occurs. In a situation where the number of vehicles mounted with an in-vehicle radar is small, the frequency of occurrence of such interference is low and the influence of the interference is small. Therefore, the above-described influence is unlikely to be shown. However, with the spread of the in-vehicle radar, there is a possibility that the frequency of occurrence of the above-described interference increases and the influence of the interference also increases. Therefore, it is desired to introduce a mechanism for further reducing the influence of the above-described interference.

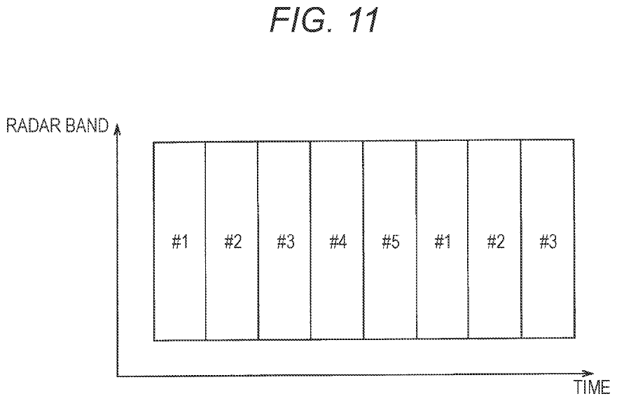

Examples of a countermeasure against interference between radars can include a method of reducing the influence of the interference by controlling, in a time-division manner, an operation between an in-vehicle radar and an infrastructure radar, or a plurality of radars (for example, front, rear, left, and right radars) mounted on a vehicle. For example, FIG. 11 is an explanatory diagram for describing an example of a method for reducing the influence of interference between radars, and illustrates an example of a resource allocated to be available for transmission of radar waves. In FIG. 11, the horizontal axis represents time and the vertical axis represents a radar band (that is, frequency).

In the example illustrated in FIG. 11, temporally divided resources #1 to #5 are allocated to different radars, respectively. As a specific example, among the resources #1 to #5 illustrated in FIG. 11, the resources #1, #3, #4, and #5 are allocated to radars installed on the front side, the rear side, the right side, and the left side among the radars mounted on the vehicle, respectively. In addition, the resource #2 is allocated to an infrastructure radar. In this way, in the example illustrated in FIG. 11, a different time slot is allocated for a role of each radar, and with such a configuration, interference between an in-vehicle radar and an infrastructure radar or interference between a plurality of radars mounted on the vehicle may be reduced.

However, in the example illustrated in FIG. 11, in a case where a radar in a vehicle uses a particular resource and a radar in another vehicle uses the same resource, interference can still occur between these radars. Furthermore, in the example illustrated in FIG. 11, a time available for transmitting radar waves tends to be shorter due to the characteristic that resource allocation is performed in a time-division manner. Therefore, the example illustrated in FIG. 11 can be applied to a radar of a method using a signal having a short transmission time (for example, pulse waves) as radar waves. However, it is difficult to apply the example illustrated in FIG. 11 to a radar that adopts a method (for example, the FCM method) using a signal having a relatively long sweep time, such as a chirp signal, and it is likely that restrictions increase even if the example illustrated in FIG. 11 can be applied to such a radar.

In view of the circumstances as described above, the present disclosure proposes, as an example of a technology that enables object detection using a wireless signal in a more preferable manner, particularly, a technology that enables further reduction of the influence of interference from another wireless signal. More specifically, the present disclosure proposes a technology that further suppresses the appearance of a virtual image by further reducing the influence of interference (in other words, interference between radar devices) from a wireless signal transmitted from each radar device, and enables a more effective utilization of a resource allocated for transmission of a wireless signal by the radar device.

In addition, a technology according to the present disclosure as described later has the purpose of solving the problem of interference between radar devices that may become more apparent in the future, and is considered as being particularly effective in formulating, by a standardization organization and the like in the future, standards, technical specifications, and the like related to a signal transmission method for various radars including an in-vehicle radar and the like. As a specific example, by managing an operation related to transmission of a wireless signal by an in-vehicle radar of each vehicle according to a specific rule, it is possible to further improve an effect of further reducing the influence of interference.

### 4. TECHNICAL ADVANTAGES

Next, technical features of the radar device according to an embodiment of the present disclosure and the system including the radar device will be described below.

<4.1. Technology Related to Reduction of Interference>

First, the basic principle of the technology that further reduces the influence of interference (in other words, interference between radar devices) from a wireless signal transmitted by each radar device in the system according to an embodiment of the present disclosure will be described below.

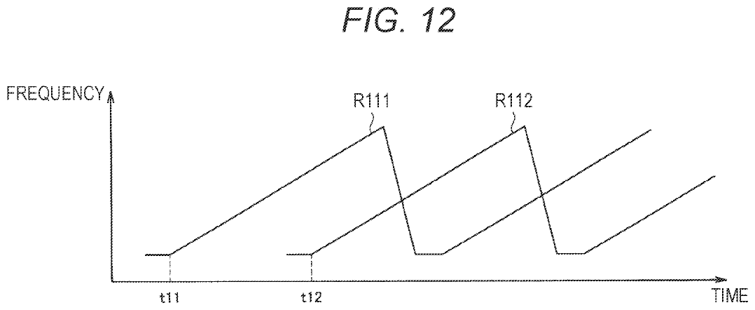

For example, FIG. 12 is an explanatory diagram for describing an example of a transmission timing of a wireless signal related to object (target) detection by the radar device according to an embodiment of the present disclosure. In the example illustrated in FIG. 12, it is assumed that a signal (for example, a chirp signal) controlled so that the frequency continuously changes in time series is used as the wireless signal. Note that, in the following description, for convenience, a case where a chirp signal is used as the wireless signal will be described.

In FIG. 12, the horizontal axis represents time and the vertical axis represents frequency. In FIG. 12, Reference Numerals R111 and R112 each indicate a chirp signal transmitted by each radar device to detect an object. Further, Reference Numerals t11 and t12 schematically indicate transmission timings of the chirp signals R111 and R112, respectively. That is, the chirp signal R111 is controlled so that the frequency continuously increases in time series from the transmission timing t11 as a base point. Further, the chirp signal R112 is controlled so that the frequency continuously increases in time series from the transmission timing t12 as a base point, the transmission timing t12 being later than the transmission timing t11.

As illustrated in FIG. 12, in the system according to the present embodiment, it is allowed that a period (hereinafter, also referred to as a “sweep period”), in which the frequency of a chirp signal transmitted by each of some radar devices is controlled to continuously change in time series, partially overlaps a part of a sweep period of other chirp signals. As a specific example, in the example illustrated in FIG. 12, a control for continuously increasing the frequency of the chirp signal R112 starts from the timing t12 that is earlier than when a control for continuously increasing the frequency of the chirp signal R111 ends.

That is, conventionally, a radar device of each vehicle transmits a chirp signal at an arbitrary timing to detect an object, whereas in the system according to an embodiment of the present disclosure, transmission of a chirp signal by each of a plurality of radar devices is controlled on the basis of a predetermined condition. As a specific example, in the system according to an embodiment of the present disclosure, each radar device performs object detection (that is, radar sensing) on the basis of a condition in which a timing as a reference for transmission of a chirp signal is shared among a plurality of radar devices included in a predetermined group, and mutual interference does not occur. That is, the radar device of each vehicle can appropriately acquire, from a base station or a central control system including the base station, a parameter (in other words, information regarding object detection) related to a condition of an operation related to object detection, the condition including the transmission timing illustrated in FIG. 12, and a plurality of radar devices can perform object detection in cooperation with each other.

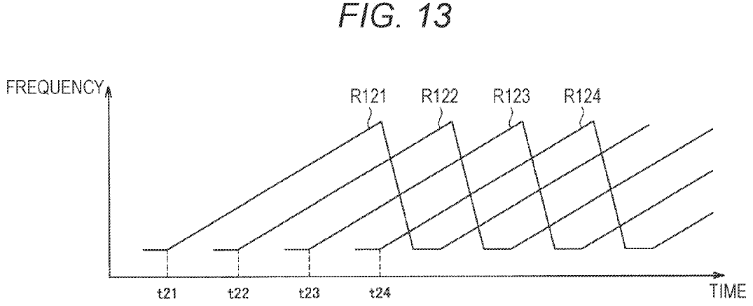

Furthermore, FIG. 13 is an explanatory diagram for describing another example of the transmission timing of the wireless signal related to object detection by the radar device according to an embodiment of the present disclosure. In the example illustrated in FIG. 12, two transmission timings (for example, the transmission timings t11 and t12) are set for a time width of a sweep period of one chirp signal (for example, the sweep period of the chirp signal R111). On the other hand, in the example illustrated in FIG. 13, four transmission timings are set for a sweep period of one chirp signal.

Specifically, the vertical and horizontal axes of the example illustrated in FIG. 13 are similar to those of the example illustrated in FIG. 12. Further, in FIG. 13, Reference Numerals R121 to R124 each indicate a chirp signal transmitted by each radar device to detect an object. Further, Reference Numerals t21 to t24 schematically indicate transmission timings of the chirp signals R121 to R124, respectively. That is, in the example illustrated in FIG. 13, four transmission timings (that is, transmission timings t21 to t24) are set for a time width of a sweep period of the chirp signal R121. In other words, in the example illustrated in FIG. 13, the sweep periods of the respective chirp signals R121 to R124 partially overlap with each other.

As a typical example, in the FCM method, a time width of a sweep period of a chirp signal is several tens of μs. Therefore, for example, in a case where a time width of a sweep period of a chirp signal is 20 μs, an interval between the transmission timings of the respective chirp signals in the example illustrated in FIG. 12 is about 10 μs. Furthermore, the interval between the transmission timings of the respective chirp signals in the example illustrated in FIG. 13 is about 5 μs. Note that setting of transmission timing candidates may be statically determined in advance. Furthermore, as another example, the central control system may dynamically or quasi-statically control the setting of transmission timing candidates. In this case, for example, the central control system may selectively switch between the transmission timing setting as in the example illustrated in FIG. 12 and the transmission timing setting as illustrated in FIG. 13 according to circumstances.

As illustrated in FIGS. 12 and 13, each radar device selects any one of a plurality of predetermined transmission timings and transmits a chirp signal at the selected transmission timing to start object detection (sensing). Note that the timing at which each radar device transmits a chirp signal is synchronized between the radar devices. The synchronization can be achieved by, for example, a control of a base station or the like, direct communication between radar devices, or the like. Note that, in the following description of this section, it is assumed that the synchronization of the transmission timing of the chirp signal between the radar devices is achieved in advance.

Examples of a method by which a radar device selects a transmission timing can include a method based on a control by the central control system configured to be able to perform communication with each radar device. The central control system, for example, groups a plurality of radar devices on the basis of a predetermined condition, and allocates a transmission timing of a chirp signal to each radar device in consideration of a condition such as the number of radar devices (for example, a vehicle including an in-vehicle radar, and the like) included in the same group, an interval (for example, an interval between vehicles) between the radar devices, and the like.

As a more specific example, the central control system may group vehicles (vehicles including an in-vehicle radar) in a cell managed by a base station for each area in the cell, and allocate a transmission timing of a chirp signal for each vehicle on the basis of a result of the grouping. Furthermore, at this time, the central control system may control the allocation of the transmission timing of the chirp signal to each vehicle included in the group so as to suppress interference between the vehicles (that is, between the radar devices) in the same group. In addition, the central control system may control the allocation of the transmission timing of the chirp signal to each vehicle, in consideration not only of the same group, but also of a situation of vehicles of another group that approach or a situation of vehicles of another group that are dispersed.

Furthermore, in this case, each radar device (for example, each vehicle) may provide, to the central control system, information of the radar device itself and information of the surroundings of the radar device, such as location information of the radar device itself, an ability related to object detection, information of a detected target, and the like. With such a configuration, the central control system can perform various controls so that a more efficient operation of the entire system (for example, reduction of interference and improvement of resource utilization efficiency, or the like) can be realized in consideration of the situation of each radar device.

Next, a mechanism capable of further reducing the influence of interference between radar devices in the system according to an embodiment of the present disclosure will be described.

In the system according to the present embodiment, it is assumed that the radar device uses millimeter waves as a transmission signal. Since the millimeter waves are electromagnetic waves, they travel about 300,000 km per second. Therefore, for example, in a case where a situation where the transmission signal is reflected from a target that is 150 m away from the radar device is assumed, a delay from a timing when the radar device transmits the transmission signal until a timing when reflected waves obtained by the reflection of the transmission signal from the target is received is 1 μs. Therefore, for example, in a case where the transmission timings t21 to t24 are set at intervals of 5 μs as in the example described with reference to FIG. 13 and a chirp signal is transmitted at the transmission timing t21, the above-described delay (1 μs) can be said to be sufficiently shorter than the interval (5 μs) between the transmission timings.

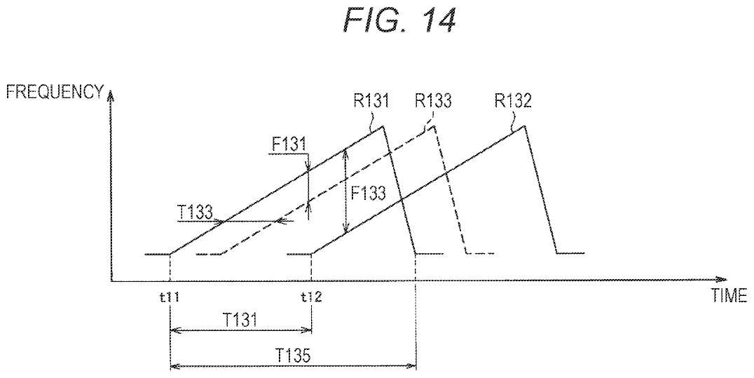

Here, an example of a relationship between a beat signal according to a transmission signal and reflected waves and a beat signal according to the transmission signal and an interference signal will be described with reference to FIG. 14. FIG. 14 is an explanatory diagram for describing an outline of a technology capable of further reducing the influence of interference between radar devices in the system according to an embodiment of the present disclosure. Specifically, FIG. 14 illustrates an example of a time relationship and a frequency relationship between a beat signal according to a transmission signal and reflected waves and a beat signal according to the transmission signal and an interference signal.

In FIG. 14, Reference Numerals R131 and R132 each indicate a chirp signal transmitted by each radar device to detect an object. Further, Reference Numerals t11 and t12 schematically indicate transmission timings of the chirp signals R131 and R132, respectively. Further, Reference Numeral R133 schematically indicates reflected waves that are obtained by reflection of a chirp signal transmitted from a radar device from a target (object), and are received by the radar device. Further, Reference Numeral T135 schematically indicates a period (a period for one cycle) in which the frequency of the chirp signal continuously changes in time series. Note that a time width of the period T135 corresponds to an example of a “first time width”.

Here, in the example illustrated in FIG. 14, a case where the transmission timing t11 is allocated to a certain radar device and the radar device transmits the chirp signal R131 will be described. For example, Reference Numeral T133 schematically indicates a delay time of the reflected waves R133 with respect to the chirp signal R131. Further, Reference Numeral F131 corresponds to a frequency difference between the chirp signal R131 and the reflected waves R133, that is, corresponds to the frequency of a beat signal based on the chirp signal R131 and the reflected waves R133. Furthermore, in this case, the chirp signal R132 may act as interference waves in a case where the above-described radar device detects a target by using a result of the reception of the reflected waves R133 of the transmitted chirp signal R131. At this time, Reference Numeral F133 corresponds to a frequency difference between the chirp signal R131 (transmission signal) and the chirp signal R132 (interference waves), that is, corresponds to the frequency of the beat signal based on the transmission signal (chirp signal R131) and the interference waves (chirp signal R132). Further, Reference Numeral T131 corresponds to a time width between the transmission timings t11 and t12, and corresponds to a time width (delay) between the chirp signal R131 (transmission signal) and the chirp signal R132 (interference waves). That is, a time width of the period T131 corresponds to an example of a “second time width”.

In the example illustrated in FIG. 14, the time width between the transmission timings t11 and t12 is sufficiently larger than a desired delay time (for example, the delay time T133 of the reflected waves R133) of reflected waves, and the frequency difference (for example, the frequency difference F133) between the transmission signal and the interference waves is sufficiently larger than the frequency difference (that is, the frequency of the beat signal, for example, the frequency difference F131) between the transmission signal and the reflected waves. From such characteristics, a frequency component due to interference waves can be easily removed by, for example, a low-pass filter (LPF) or the like. Note that a time width of a delay time between a transmission signal and reflected waves (that is, the reflected waves passing through the filter) used for target detection, that is, the time width of the delay time T133 corresponds to an example of a “third time width”.

In a radar using the FMCW method, generally, a mixer output of a receiver is AD-converted into a digital signal by an AD converter to perform signal processing, and it is possible to remove the frequency component of the interference waves described above by using a low-pass filter provided for removing aliasing in the AD conversion. Further, even after the AD conversion, a desired frequency component and a frequency component of interfering waves can be easily discriminated by the distance FFT applied to extract distance information from a beat signal.

As a more specific example, it is assumed that an interval (that is, the time width T131 illustrated in FIG. 11) between transmission timings of the respective chirp signals is set to 5 μs. In such a case, the filtering mechanism described above makes it possible to easily exclude 750 m, which is a distance corresponding to the delay of 5 μs, as being outside the target detection range.

However, the interval (time width) between the transmission timings of the respective chirp signals may be restricted depending on performance required by a radar device to be used, and thus it is not always possible to reduce the interval arbitrarily.

In general, a distance to a target to be detected by a practical millimeter-wave in-vehicle radar is up to about 250 m with a so-called long range rader (LRR). Therefore, in a case of the long range radar, a minimum value of the interval between the transmission timings of the respective chirp signals is 2 μs (corresponding to a distance of 300 m).

Further, as another example, in a case of so-called middle range rader (MRR), if a maximum range is 120 m, the minimum value of the interval between the transmission timings of the respective chirp signals is 1 μs (corresponding to a distance of 150 m). In addition, in a case of setting a short range rader (SRR) with a shorter maximum range than the medium range radar described above, for the short range radar, it goes without saying that the interval between transmission timings of the respective chirp signals is shorter than that of the medium range radar due to the maximum range.

As described above, the minimum value of the interval between the transmission timings of the respective chirp signals depends on the maximum range (that is, the maximum value of the distance to the target to be detected) assumed by the radar device to be used. Note that, in a case where the interval between the transmission timings of the respective chirp signals is set in consideration of the maximum range assumed by the radar device to be used, the transmission timing of each chirp signal does not necessarily have to be set by dividing a sweep period of one chirp signal into equal intervals as in the examples illustrated in FIGS. 12 and 13.

Further, the number of chirp signal transmission timings that can be set during a sweep period of one chirp signal depends on the length of the sweep period. For example, in a case of setting a transmission timing of a chirp signal by dividing a sweep period of one chirp signal into equal intervals as in the examples illustrated in FIGS. 12 and 13, the longer the sweep time of the used chirp signal, the larger the number of transmission timings resulting from the division. As a more specific example, in a case where a sweep period of one chirp signal is 100 μs and the transmission timings are set at intervals of 2 μs, each radar device can select a transmission timing of a chirp signal transmitted by itself from 50 transmission timings. Note that, in a case where the interval between the transmission timings of the respective chirp signals is set in consideration of a sweep period of each chirp signal, the transmission timing of each chirp signal does not necessarily have to be set by dividing a sweep period of one chirp signal into equal intervals as in the examples illustrated in FIGS. 12 and 13.

In a radar using the FMCW method, a maximum range dₘₐₓ of the radar is expressed by the following formula shown as (Equation 2).

$$[ Math . 2 ]$$

$${d}_{max} = \frac{{f}_{s} c}{2 S} \qquad ( Equation 2 )$$

In the above-described (Equation 2), S indicates a slope (that is, frequency/time) of a chirp signal. Further, fs indicates a sampling frequency of the AD converter. Further, c indicates the speed of light. From the above-described (Equation 2), it can be seen that in a case of detecting a more distant target at the same sampling frequency, it is necessary to make a value of the slope S of the chirp signal smaller. As a more specific example, in a case where fs is 20 MHz and the maximum range dₘₐₓ is 250 m, the slope of the chirp signal is S=12 MHz/μs. Therefore, if the band of 1 GHz is available, it is possible to control a value of S/N to be maximized by setting the sweep period of the chirp signal to about 83 μs.

On the other hand, in a case where an index indicating how finely the radar device can detect a distance to a target is distance resolution Ad, the distance resolution Ad is expressed by the following formula shown as (Equation 3).

$$[ Math . 3 ]$$

$$Δ d = \frac{c}{2 B} \qquad ( Equation 3 )$$

In the above-described (Equation 3), B corresponds to a chirp bandwidth of an FMCW signal used. It can be seen from the above-described (Equation 3) that a wider band is required to obtain higher resolution. As a specific example, a band required to set the distance resolution Ad to 15 cm is 1 GHz.

In this way, setting of a required sweep period of a chirp signal or an available frequency bandwidth is determined according to a distance to a target to be detected or distance resolution related to the detection. Therefore, the setting of a required sweep period of a chirp signal, the setting of a required frequency bandwidth, and the like are different between the LRR and the SRR.

More specifically, in a case of the LRR, a relatively long time width is required as the sweep period of the chirp signal in order to obtain a favorable S/N of the signal after reception. On the other hand, in the LRR, a slope (S value) of the chirp signal is relatively small, because the above-described sweep period is long. Therefore, the required frequency bandwidth tends to be relatively narrow.

On the other hand, in a case of the SRR, the S/N tends to be high, and thus the sweep period of the chirp signal may be relatively short (at least, it may be shorter than that in a case of the LRR). On the other hand, in the SRR, a relatively wide frequency bandwidth (at least, a wider frequency bandwidth than that in a case of the LRR) is required in order to detect the location of the target with higher resolution.

In view of the situation as described above, in a case where respective radar devices for different purposes occupy resources, it is desired to use the frequency band in consideration of each usage condition.

<4.2. Technology that Enables Efficient Use of Resources>

Next, the basic principle of the technology that enables more efficient use of resources according to a usage condition of each radar device will be described.

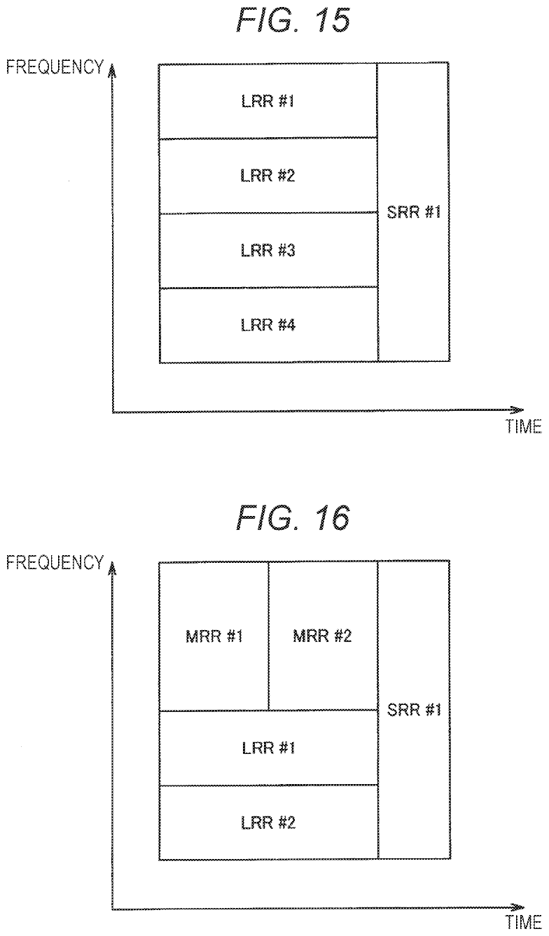

For example, FIG. 15 is an explanatory diagram for describing an example of a resource allocation method according to a usage condition of the radar device. Specifically, FIG. 15 illustrates an example of a case where resources available for target detection (that is, resources available to the radar device) are divided in a time-division manner and a frequency-division manner, and allocated to each of an SRR device and an LRR device. In FIG. 15, the horizontal axis represents time. In addition, the vertical axis indicates a frequency, and in particular, shows a frequency band available to the radar device.

As described above, in a case of the LRR, a relatively long time width is required as the sweep period of the chirp signal, but the required frequency bandwidth tends not to be very wide. Therefore, in the example illustrated in FIG. 15, as indicated by LRR #1 to LRR #4, resource regions divided so that a width in a time axis direction is wider than that in a frequency axis direction are allocated as resources used for the LRR.

Further, in the example illustrated in FIG. 15, as indicated by SRR #1, a partial resource region divided in the time axis direction is allocated as a resource used for the SRR. Note that, as described above, in a case of the SRR, a relatively wide frequency bandwidth is required, but the sweep period of the chirp signal tends to be relatively short. Therefore, in the example illustrated in FIG. 15, as indicated by SRR #1, a resource region divided so that a width in the frequency axis direction is wider than that in the time axis direction is allocated as a resource used for the SRR.

By allocating resources as illustrated in FIG. 15, the resources available for the LRR are multiplexed in the frequency direction, such that the capacity of the radar device can be further improved. In addition, since the resources available for the SRR are allocated in a fixed cycle, it is permissible for the SRR device to be operated in each cycle.

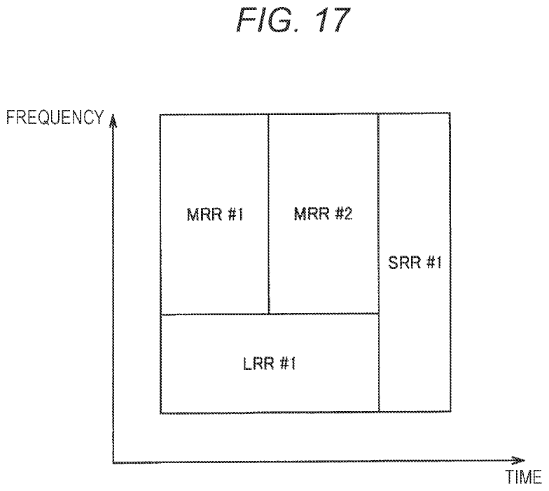

In addition, FIGS. 16 and 17 are each an explanatory diagram for describing another example of the resource allocation method according to the usage condition of the radar device, and illustrates an example of a case where resources available for the MRR, in addition to the SRR and the LRR are allocated.

First, an example illustrated in FIG. 16 will be described. In the example illustrated in FIG. 16, resources LRR #1 and LRR #2 available for the LRR are allocated to a lower frequency band than resources MRR #1 and MRR #2 available for the MRR. This is because, in general, the higher the frequency, the shorter the reach of radio waves, and in a frequency band near 70 GHz to 100 GHz, the higher the frequency, the greater the attenuation of radio waves due to the influence of water vapor and the like.

In addition, in a case of assuming the use of a wide band of 76 GHz to 81 GHz as a frequency band available to the radar device, resource allocation according to the purpose of the radar device as described above can be assumed in consideration of the ease of implementation of the antenna. That is, the frequency allocation to each radar device may be controlled so that a resource in the lower frequency band can be allocated to a radar device in which a distance to a target to be detected is set to be longer.

Next, the example illustrated in FIG. 17 will be described. Compared to the example illustrated in FIG. 16, in the example illustrated in FIG. 17, a resource region controlled so that a width in the frequency direction is increased is allocated to the MRR by reducing the number of multiplexed resources allocated for the LRR.

Note that the examples illustrated in FIGS. 15 to 17 are merely examples, and a combination of arrangement of resource regions according to the intended use may be changed as appropriate. For example, an order in which respective regions are arranged in a time-series manner may be changed. As a more specific example, in the examples illustrated in FIGS. 16 and 17, a resource region available for the SRR may be allocated to be positioned in advance of (that is, an earlier timing) resource regions available for the LRR and the MRR in the time axis direction.

As described above, the classification of resources to be allocated is controlled according to the purpose of each radar device (in other words, a distance to a target to be detected or the required performance such as resolution related to detection or the like). Therefore, it is possible to further improve the utilization efficiency of the resources available for wireless communication (particularly, target detection) of the entire system.

<4.3. Example of Configuration and Processing Related to Control of Operation of Radar Device>

Next, for an example of a configuration and processing related to a control of an operation related to detection of a target (an object or the like) by each radar device (for example, each vehicle), in particular, a case of controlling an operation related to transmission of a wireless signal (for example, a chirp signal) by the radar device will be described.

(Example of Configuration of Radar Device)

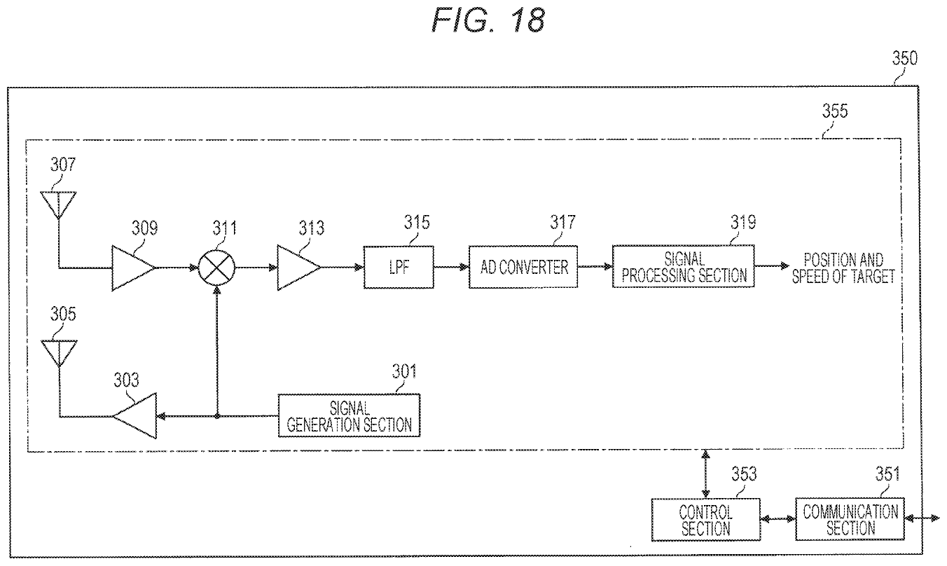

First, an example of a functional configuration of a radar device according to an embodiment of the present disclosure will be described with reference to FIG. 18. FIG. 18 is a block diagram illustrating an example of a functional configuration of a radar device according to an embodiment of the present disclosure. Note that, in the following description, the radar device according to the present embodiment may be referred to as a “radar device 350” in order to distinguish it from the radar device 300 described with reference to FIG. 4.

As illustrated in FIG. 18, the radar device 350 includes a radar unit 355, a communication section 351, and a control section 353. The radar unit 355 is a portion corresponding to the radar device 300 described with reference to FIG. 4. Therefore, a detailed description of the radar unit 355 will be omitted.

The communication section 351 is a configuration for each component of the radar device 350 to perform communication with another device via a predetermined communication path. For example, in a case where the radar device 350 is configured as a mobile object such as a vehicle or the like, the communication section 351 may be configured to be able to perform communication with another device (for example, a base station or the like) via a wireless communication path.

Further, the communication path between the communication section 351 and another device is not limited to the wireless communication path, and can be appropriately changed according to the configuration of the radar device 350 or another device. For example, the communication section 351 may be configured to be able to perform communication with another device not only via the wireless communication path, but also via, for example, a wired communication path.

Further, even in a case where the radar device 350 is configured as a mobile object, another device with which the communication section 351 performs communication is not limited to the base station, and a communication scheme may be changed according to a communication partner. For example, the communication section 351 may perform so-called V2X communication such as vehicle-to-infrastructure (V2I) communication with a wireless communication unit installed on a roadside as a communication partner, vehicle-to-vehicle (V2V) communication with another vehicle as a communication partner, and the like. Further, the communication section 351 may use any communication means linked to some kind of intelligent transport system (ITS) such as dedicated short range communications (DSRC) or the like. Note that the configuration of the communication section 351 may be appropriately changed according to the communication path, the communication means, or the like.

The control section 353 controls an operation of the radar unit 355. For example, the control section 353 may perform communication with another device via the communication section 351 to control the operation of the radar unit 355 on the basis of a control of the another device. As a specific example, the control section 353 may acquire, as information regarding a transmission condition of a wireless signal (for example, a chirp signal) used for target detection, information regarding a transmission timing or information regarding a resource available for transmission of the wireless signal, from another device. In this case, the control section 353 may control an operation related to transmission or reception of the wireless signal described above by the radar unit 355 on the basis of the acquired information. Further, the control section 353 may transmit, to another device (for example, a base station or the like), a request regarding allocation of the transmission timing described above and allocation of the resource described above via the communication section 351. That is, the control section 353 can be realized as, for example, at least some components included in the control section 240 in the terminal device 200 illustrated in FIG. 3.

Note that the configuration illustrated in FIG. 18 is merely an example, and does not necessarily limit the configuration of the radar device 350. As a specific example, some components in each configuration of the radar device 350 illustrated in FIG. 15 may be externally attached to the radar device 350, as external components of the radar device 350. Further, at least some components in each configuration of the radar device 350 may be configured so that a plurality of units is operated in cooperation with each other. As described above, some components of the radar device 350 may be appropriately changed, and other components may be added, as long as such a change and addition do not deviate from the basic idea of the technology according to an embodiment of the present disclosure described above.

Hereinabove, an example of the functional configuration of the radar device according to an embodiment of the present disclosure has been described with reference to FIG. 18.

(Example of Configuration of System)

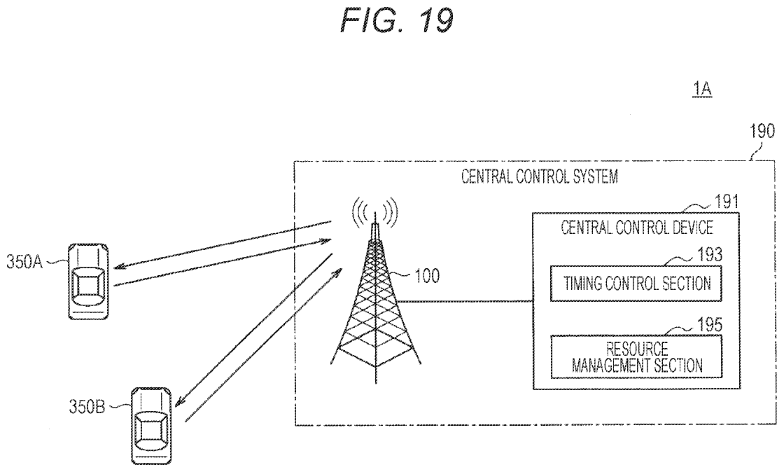

Next, an example of a configuration of a system according to an embodiment of the present disclosure will be described with reference to FIG. 19. FIG. 19 is an explanatory diagram for describing an example of a configuration of a system according to an embodiment of the present disclosure, and illustrates an example of a system assuming a case where the radar device 350 described with reference to FIG. 18 can be configured as a mobile object such as a vehicle or the like. Note that, in the following description, the system illustrated in FIG. 19 may be referred to as a “system 1A” for convenience.

As illustrated in FIG. 19, the system 1A includes a central control system 190 and one or more radar devices 350. For example, in the example illustrated in FIG. 19, the system 1A includes radar devices 350A and 350B as one or more radar devices 350. Note that, in a case where each radar device 350 can be configured as a mobile object such as a vehicle or the like, the radar device 350 can correspond to the terminal device 200 in the system 1 described with reference to FIG. 1.

The central control system 190 performs communication with each radar device 350 via a wireless communication path to control an operation of the radar device 350, particularly, an operation in which the radar device 350 detects a target (object) by using a wireless signal (for example, a chirp signal). Specifically, the central control system 190 includes a base station 100 and a central control device 191. The base station 100 corresponds to, for example, the base station 100 in the system 1 described with reference to FIG. 1. Note that the central control system 190 may include a plurality of base stations 100.

The central control device 191 is configured to be able to perform communication with the base station 100, and performs communication with the radar device 350 located within a communication range of the base station 100 via the base station 100 to control the operation of the radar device 350. As a specific example, the central control device 191 includes a timing control section 193 and a resource management section 195.

The timing control section 193 controls a transmission timing of a wireless signal (for example, a chirp signal) used by each radar device 350 to detect a target. As a specific example, the timing control section 193 controls a transmission timing to be allocated to each radar device 350 among a plurality of transmission timings set as in the examples illustrated in FIGS. 12 and 13 according to various conditions. As a more specific example, the timing control section 193 may allocate different transmission timings to a plurality of radar devices 350 present in the same area (for example, in the same region among regions divided in a cell of the base station 100). In this way, the timing control section 193 may allocate a transmission timing to each radar device 350 so that interference between the radar devices is further reduced.

The resource management section 195 controls allocation of a resource available to each radar device 350 for transmission of a wireless signal (for example, a chirp signal) described above. For example, the resource management section 195 may control the allocation of a resource to each radar device 350 according to the purpose of the radar device 350, as described with reference to FIGS. 15 to 17.

Note that the configuration illustrated in FIG. 19 is merely an example, and does not necessarily limit the configuration of the system 1A. As a specific example, as described above, the central control system 190 may include a plurality of base stations 100. That is, the central control device 191 may be configured to be able to perform communication with each of the plurality of base stations 100. Further, at least some components of the central control device 191 may be included in the base station 100. Further, the function of the central control device 191 may be realized by operating a plurality of devices in cooperation with each other. In this case, for example, the function of the timing control section 193 and the function of the resource management section 195 may be executed by different devices, respectively. Further, the function of the timing control section 193 and the function of the resource management section 195 may be realized by distributed processing performed by a plurality of devices. Further, a plurality of central control systems 190 may be operated in cooperation with each other. As a specific example, the central control systems 190 set to cover different areas may be operated in cooperation with each other to control an operation related to target detection by the radar device 350 (for example, a mobile object such as a vehicle or the like) that moves between the areas.

Hereinabove, an example of the configuration of the system according to an embodiment of the present disclosure has been described with reference to FIG. 19.

### Example 1

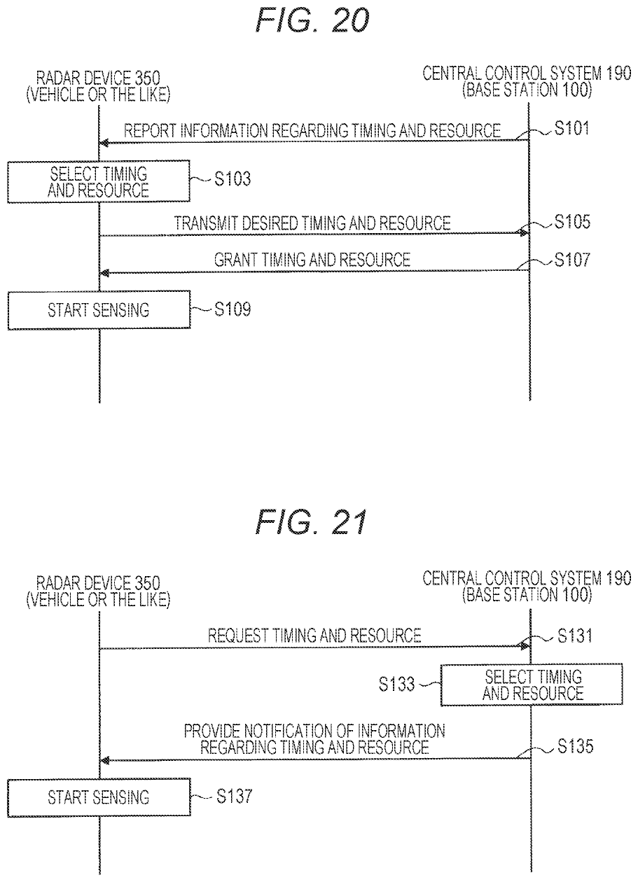

Next, as an example of the system according to an embodiment of the present disclosure, an example of a flow of a series of processing related to a control of an operation of a radar device (for example, a vehicle or the like) will be described. First, as Example 1, an example of a processing flow in a case where the central control system 190 controls an operation of each radar device 350 will be described with reference to FIG. 20. FIG. 20 is a sequence diagram illustrating an example of a flow of a series of processing of the system according to Example 1, and illustrates an example of a processing flow in which the central control system 190 controls an operation related to target detection by the vehicle 350. Note that, in the following description, each radar device 350 uses a chirp signal for target detection, as in the example described with reference to FIGS. 12 to 14.

As illustrated in FIG. 20, first, the central control system 190 reports, to the radar device 350 (for example, a vehicle or the like) within the communication range via a wireless communication path in advance, information regarding detection of a target (object) based on reflected waves obtained by reflection of a transmitted chirp signal from the target (hereinafter, also simply referred to as “information regarding target detection”). As a specific example, the central control system 190 reports, to the radar device 350, information regarding candidates of a transmission timing of the chirp signal, or information regarding a frequency band or frequency partition available for transmission of the chirp signal (in other words, information regarding an allocatable resource) (S101). Note that communication via a wireless communication path between the central control system 190 and the radar device 350 can be realized, for example, as communication between the base station 100 and the radar device 350. That is, the central control device 191 in the central control system 190 can perform communication with the radar device 350 within the communication range (for example, in the cell) of the base station 100 via the base station 100, for example. Further, examples of the candidate of the transmission timing of the chirp signal can include an example of the transmission timing described with reference to FIGS. 12 and 13. Further, examples of the information regarding a frequency band or frequency partition available for transmission of the chirp signal can include information regarding a resource region divided in the time axis direction or the frequency axis direction described with reference to FIGS. 15 to 17 (that is, information regarding a frequency band or frequency partition).

The radar device 350 selects various conditions related to target detection using the chirp signal on the basis of the information reported from the central control system 190. As a specific example, the radar device 350 selects a transmission timing desired to be used for transmission of the chirp signal among candidates on the basis of the information regarding the candidates of the transmission timing of the chirp signal, reported from the central control system 190. Further, the radar device 350 selects a resource or a resource partition desired to be allocated in order to transmit the chirp signal on the basis of the information regarding the frequency band or frequency partition, reported from the central control system 190 (S103).

However, at this point, since each radar device 350 performs the selection voluntarily, there is a possibility that a selection result is biased. Therefore, each radar device 350 may query the central control system 190 for final resource determination. Further, each radar device 350 may select a transmission timing or resource that is estimated to be best among transmission timings or resources as candidates by monitoring a wireless environment. Further, each radar device 350 may probabilistically determine a transmission timing or resource desired to be used on the basis of a random number assigned in advance. Further, each radar device 350 may determine a transmission timing or resource corresponding to a specific value calculated arithmetically on the basis of a unique number given to the communication means.

Then, the radar device 350 transmits, to the central control system 190, information regarding a result of the selection of various conditions (for example, a transmission timing, a resource, and the like) related to target detection using the chirp signal (S105). Upon receiving the notification of the information regarding the result of the selection of the conditions described above from the radar device 350, the central control system 190 checks the information and determines whether or not to permit an operation under the conditions notification of which is provided. Further, at this time, the central control system 190 may determine whether or not to permit an operation under conditions desired by each radar device 350, in consideration of conditions desired by another radar device 350. Then, the central control system 190 notifies the radar device 350 of a result of determination of whether or not to permit the operation under the conditions desired by each radar device 350 (S107).

In a case where the operation under the desired conditions is permitted by the central control system 190, the radar device 350 starts the operation related to target detection based on the conditions. As a specific example, the radar device 350 uses a resource permitted by the central control system 190 and starts transmission of the chirp signal at a transmission timing permitted by the central control system 190 (S109).

As described above, in the system according to Example 1, for example, the central control system 190 can control, in consideration of a situation of each radar device 350, conditions (for example, a transmission timing and a resource) of an operation related to target detection by the radar device 350. In this way, as the central control system 190 controls the operation related to target detection by each radar device 350, the influence of interference between the radar devices 350 can be further reduced.

Hereinabove, as Example 1, an example of the processing flow in a case where the central control system 190 controls an operation of each radar device 350 has been described with reference to FIG. 20.

### Example 2

Next, as Example 2, another example of a processing flow in a case where the central control system 190 controls an operation of each radar device 350 will be described with reference to FIG. 21. FIG. 21 is a sequence diagram illustrating an example of a flow of a series of processing of a system according to Example 2, and illustrates an example of a processing flow in which the central control system 190 controls an operation related to target detection by the vehicle 350.

In the system according to Example 2, processing associated with setting of conditions of an operation related to target detection (for example, allocation of a transmission timing or a resource, or the like) starts from the radar device 350 as a starting point.

Specifically, as illustrated in FIG. 21, each radar device 350 requests the central control system 190 to perform setting (for example, allocation of a transmission timing or a resource) of various conditions of an operation related to target detection at an arbitrary timing regardless of whether or not information is reported from the central control system 190 (S131).

Upon receiving the request described above from the radar device 350, the central control system 190 selects the conditions of the operation related to target detection by the radar device 350. As a specific example, the central control system 190 selects the transmission timing of the chirp signal to be allocated to the radar device 350 among a plurality of candidates. Further, the central control system 190 may also select a resource to be allocated to the radar device 350 (S133).

Then, the central control system 190 notifies the radar device 350 of information regarding a result (for example, a result of allocation of a transmission timing or a resource) of the selection of the conditions of the operation related to target detection by the radar device 350 (S135).

Upon receiving the notification of the information regarding the result of the selection of the conditions of the operation related to target detection from the central control system 190, the radar device 350 starts the operation related to target detection based on the conditions. As a specific example, the radar device 350 uses a resource allocated by the central control system 190 and starts transmission of the chirp signal at a transmission timing allocated by the central control system 190 (S137).

Hereinabove, as Example 2, another example of the processing flow in a case where the central control system 190 controls an operation of each radar device 350 has been described with reference to FIG. 21.

### Example 3

Next, as Example 3, an example of a flow of a series of processing in a case where some radar devices 350 serve as the central control system 190 in response to a request from the central control system 190 will be described. Note that, in the following description, a radar device 350 that serves as the central control system 190 is also referred to as a “master device”. Further, in a case where the radar device 350 is configured as a vehicle, the radar device 350 corresponding to the “master device” is also referred to as a “master vehicle”. Further, the radar device 350 operated as the master device corresponds to an example of a “first terminal device”. Further, a radar device 350 other than the master device corresponds to an example of a “second terminal device”.

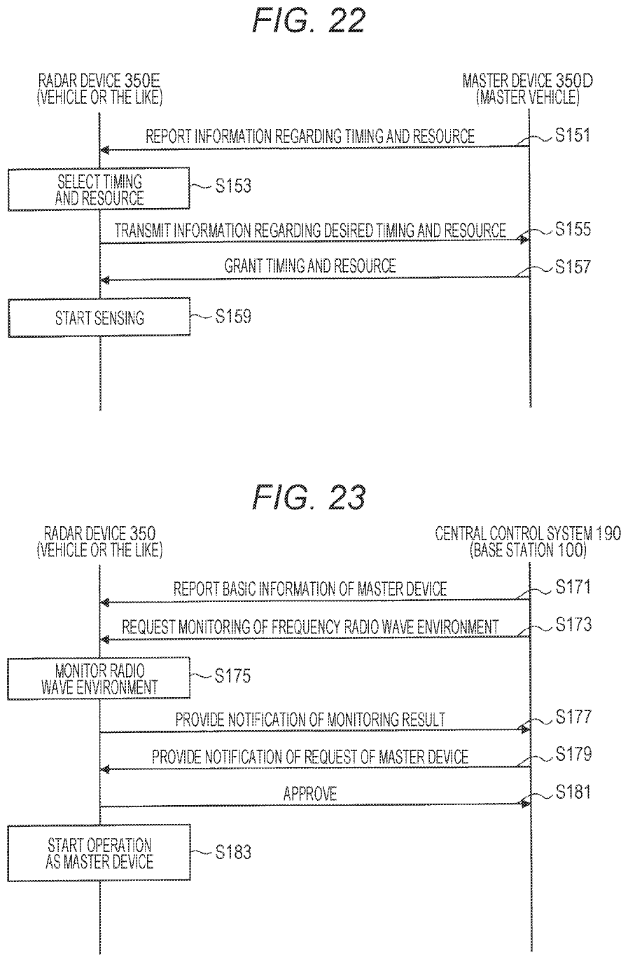

First, an example of a flow of a series of processing in a case where the radar device 350 operated as the master device serves as the central control system 190 will be described with reference to FIG. 22. FIG. 22 is a sequence diagram illustrating an example of a flow of a series of processing of a system according to Example 3, and illustrates an example of a case where the radar device 350 operated as the master device serves as the central control system 190. Note that, in the example illustrated in FIG. 22, for convenience, the radar device operated as the master device is referred to as a “master device 350D”, and another radar device that is not operated as the master device is referred to as a “radar device 350E”.

As illustrated in FIG. 22, first, the master device 350D reports, to the surrounding radar device 350E in advance, information regarding target detection via a wireless communication path (S151). Note that it is assumed that communication between the master device 350D and the radar device 350E is, for example, direct or indirect device-to-device (for example, vehicle-to-vehicle) communication including V2X communication. Further, the information reported from the master device 350D to the radar device 350E corresponds to, for example, the information reported from the central control system 190 to the radar device 350 in the system (see FIG. 20) according to Example 1 described above.

The radar device 350E selects various conditions (for example, a transmission timing, a resource, and the like) related to target detection using a chirp signal on the basis of the information reported from the master device 350D (S153).

Then, the radar device 350E transmits, to the master device 350D, information regarding a result of the selection of various conditions (for example, a transmission timing, a resource, and the like) related to target detection using the chirp signal (S155). Upon receiving the notification of the information regarding the result of the selection of the conditions described above from the radar device 350E, the master device 350D checks the information and determines whether or not to permit an operation under the conditions notification of which is provided. Further, at this time, the master device 350D may determine whether or not to permit an operation under conditions desired by the radar device 350E, in consideration of conditions desired by another radar device 350. Then, the master device 350D notifies the radar device 350E of a result of determination of whether or not to permit the operation under the conditions desired by the radar device 350E (S157).

In a case where the operation under the desired conditions is permitted by the master device 350D, the radar device 350E starts the operation related to target detection based on the conditions. As a specific example, the radar device 350E uses a resource permitted by the master device 350D and starts transmission of the chirp signal at a transmission timing permitted by the master device 350D (S159).

Next, an example of a flow of a series of procedures until some radar devices 350 perform a transition to an operation as the master device in response to a request from the central control system 190 will be described with reference to FIG. 23. FIG. 23 is a sequence diagram illustrating an example of a flow of a series of processing of the system according to Example 3, and illustrates an example of a flow of a series of procedures until some radar devices 350 perform a transition to an operation as the master device in response to a request from the central control system 190.

As illustrated in FIG. 23, the central control system 190 reports, to at least some of the respective radar devices 350 within a communication range, information regarding basic conditions of an operation as the master device (hereinafter, also referred to as “basic information”) (S171). Examples of the basic information may include information such as a start time and end time of the operation as the master device, a start condition and end condition of the operation as the master device, a hardware condition required for the master device, and the like. Further, in a case where the radar device 350 is configured as a mobile object such as a vehicle or the like, information such as a vehicle running condition suitable for the master vehicle or the like may be included as the basic information.

In addition, the central control system 190 requests the radar device 350, to which the basic information is reported, to monitor a surrounding radio wave environment (S173). Further, at this time, the central control system 190 may include, in the request, information regarding a condition of the monitoring of the radio wave environment.

The radar device 350 receiving the basic information from the central control system 190 starts monitoring of the surrounding radio wave environment in response to the request for the monitoring of the surrounding radio wave environment. Further, at this time, in a case where the request includes the information regarding the condition of the monitoring of the radio wave environment, the radar device 350 may monitor the radio wave environment according to the condition (S175).

More specifically, the radar device 350 checks whether or not the radar device 350 includes hardware that meets the conditions specified in the basic information. In addition, in a case where the basic information includes the information regarding the vehicle running condition suitable for the master vehicle, the radar device 350 (vehicle) checks whether or not the radar device 350 meets the conditions by referring to driving data such as a vehicle speed history, a current position history, and the like. Then, in a case where the radar device 350 checks that the radar device 350 satisfies the conditions as the master device, the radar device 350 starts monitoring the surrounding radio wave environment. Specifically, the radar device 350 activates a receiving circuit of the radar during a period from the start time to the end time of the operation as the master device, the start time and the end time being specified as the basic information, and measures a signal level of a radar band in the surrounding environment.

Then, in a case where the monitoring of the surrounding radio wave environment is performed, the radar device 350 notifies the central control system 190 of a result of the monitoring (S177). Further, in a case where the radar device 350 is configured as a mobile object such as a vehicle or the like, the radar device 350 may notify the central control system 190 of the information by associating information according to driving data (for example, a vehicle speed history, a position history, and the like) of the radar device 350 with the result of the monitoring.

The central control system 190 determines the radar device 350 to be requested to be operated as the master device on the basis of the monitoring result notification of which is provided from each radar device 350. For the master device, it is desirable that there are no large interference waves in the band. Therefore, the central control system 190 may determine that the radar device 350 having a high interference level is not suitable as the master device. Further, in a case where the radar device 350 is configured as a mobile object such as a vehicle or the like, the central control system 190 may determine the radar device 350 requested to be operated as the master device in consideration of the information according to the running data of the radar device 350 (vehicle). As a specific example, the central control system 190 may determine the radar device 350 that is suitable as the master device (master vehicle) by taking a positional relationship between the radar devices 350 (a positional relationship between vehicles) into consideration, on the basis of a position history of each radar device 350. Further, the central control system 190 may exclude the radar device 350 that is not suitable as the master device (master vehicle) from candidates on the basis of a speed history of each radar device 350.

Further, the central control system 190 may utilize the monitoring result notification of which is provided from each radar device 350 as information for allocating a resource. As a specific example, it is possible to sense that an extremely large number of vehicles are unevenly distributed in a specific area due to traffic congestion or the like, on the basis of a relationship such as the number of vehicles, a speed, a distance between vehicles, or the like. Therefore, in a case where such a situation is sensed, the central control system 190 may select, for example, a resource allocation method that enables a more efficient utilization of a resource in a situation where congestion occurs.

Then, once the radar device 350 suitable as the master device is specified, the central control system 190 notifies the radar device 350 of a request for the operation as the master device (S181). The radar device 350 receiving the notification of the request determines whether or not to approve the operation as the master device, and in a case where the operation is approved, the radar device 350 notifies the central control system 190 of information regarding the approval (S181). Then, the radar device 350 starts the operation as the master device (S183).

With the configuration as described above, the central control system 190 can also delegate a role thereof to some radar devices 350. As a result, for example, the processing performed by the central control system 190 can be distributed and performed by a plurality of devices according to circumstances.

As described above, as Example 3, the example of a flow of a series of processing in a case where some radar devices 350 serve as the central control system 190 in response to a request from the central control system 190 has been described with reference to FIGS. 22 and 23.

### 5. APPLICATION EXAMPLE

Next, an application example of the technology according to the present disclosure will be described. The technology according to the present disclosure can be applied to various products. For example, the base station 100 may be realized as any kind of evolved Node B (eNB) such as a macro eNB or a small eNB. The small eNB may be an eNB that covers a cell smaller than a macrocell, such as a pico eNB, a micro eNB, or a home (femto) eNB. Alternatively, the base station 100 may be realized as another type of base station such as a NodeB or a base transceiver station (BTS). The base station 100 may include a main body (also referred to as a base station device) that controls wireless communication, and one or more remote radio heads (RRHs) that are arranged at a location different from that of the main body. Further, various types of terminals as described later may be operated as the base station 100 by temporarily or semi-permanently executing the base station function.

Further, for example, the terminal device 200 may be implemented as a smartphone, a tablet personal computer (PC), a notebook PC, a portable game terminal, a mobile terminal such as a portable/dongle type mobile router, a digital camera, or the like, or an in-vehicle terminal such as a car navigation device. Further, the terminal device 200 may be realized as a terminal (also referred to as a machine type communication (MTC) terminal) that performs machine to machine (M2M) communication. Moreover, the terminal device 200 may be a wireless communication module (for example, an integrated circuit module configured with one die) mounted on these terminals.

Further, as an example of a case where the radar device 350 corresponding to the terminal device 200 is configured as a mobile object, in particular, a case where the radar device 350 is configured as a vehicle has been described above. However, application of a case where the radar device 350 is configured as a mobile object is not necessarily limited to the vehicle. As a specific example, the radar device 350 may be configured as a drone, an autonomous robot, or the like. Further, the radar device 350 itself does not have to be configured as a mobile object. That is, the radar device 350 may be configured as a radar device mounted on a mobile object. Further, it is also possible to apply the radar device 350 to a device other than a mobile object. As a specific example, the radar device 350 according to the present embodiment may be applied as an infrastructure terminal such as an RSU or the like.

<5.1. Application Example Related to Base Station>

### First Application Example

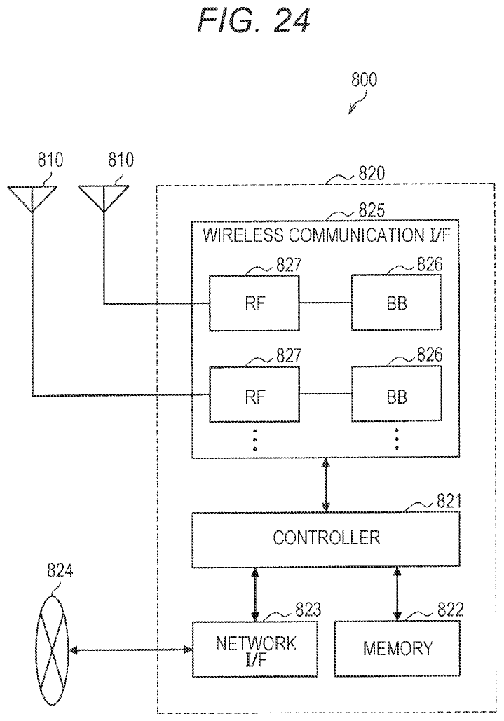

FIG. 24 is a block diagram illustrating a first example of a schematic configuration of an eNB to which the technology according to the present disclosure can be applied. An eNB 800 includes one or more antennas 810 and a base station device 820. Each antenna 810 and the base station device 820 may be connected to each other via an RF cable.

Each of the antennas 810 includes a single or multiple antenna elements (for example, a plurality of antenna elements constituting a MIMO antenna) and is used for transmission and reception of a wireless signal by the base station device 820. The eNB 800 includes a plurality of antennas 810 as illustrated in FIG. 24, and the plurality of antennas 810 may correspond to, for example, a plurality of frequency bands used by the eNB 800, respectively. Note that although FIG. 24 illustrates an example in which the eNB 800 includes a plurality of antennas 810, the eNB 800 may include a single antenna 810.

The base station device 820 includes a controller 821, a memory 822, a network interface 823, and a wireless communication interface 825.

The controller 821 may be, for example, a central processing unit (CPU) or a digital signal processor (DSP) and perform control to operate various functions of the upper layer of the base station device 820. For example, the controller 821 generates a data packet from data in a signal processed by the wireless communication interface 825 and forwards the generated packet via the network interface 823. The controller 821 may generate a bundled packet by bundling data from a plurality of baseband processors and forward the generated bundled packet. In addition, the controller 821 may have logical functions of performing a control such as a radio resource control, a radio bearer control, mobility management, an admission control, scheduling, or the like. Further, the control may be performed in cooperation with the surrounding eNB or the core network node. The memory 822 includes a random access memory (RAM) and a read only memory (ROM), and stores a program executed by the controller 821 and various control data (for example, a terminal list, transmission power data, scheduling data, and the like).

The network interface 823 is a communication interface for connecting the base station device 820 to a core network 824. The controller 821 may perform communication with a core network node or another eNB via the network interface 823. In that case, the eNB 800, and the core network node or another eNB may be connected to each other by a logical interface (for example, an S1 interface or X2 interface). The network interface 823 may be a wired communication interface or a wireless communication interface for a wireless backhaul. In a case where the network interface 823 is a wireless communication interface, the network interface 823 may use, for wireless communication, a frequency band higher than a frequency band used by the wireless communication interface 825.

The wireless communication interface 825 supports any one of cellular communication schemes such as long term evolution (LTE), LTE-Advanced, or the like, and provides wireless connection to a terminal located in a cell of the eNB 800 via the antenna 810. The wireless communication interface 825 may typically include a baseband (BB) processor 826, an RF circuit 827, and the like. The BB processor 826 may perform, for example, encoding/decoding, modulation/demodulation, multiplexing/demultiplexing, and the like, and may perform various signal processing of each layer (for example, L1, medium access control (MAC), radio link control (RLC), and packet data convergence protocol (PDCP)). Instead of the controller 821, the BB processor 826 may have some or all of the above-described logical functions. The BB processor 826 may be a module including a memory that stores a communication control program, a processor that executes the program, and a related circuit, and the functions of the BB processor 826 may be changed by updating the above-described program. Further, the above-described module may be a card or a blade to be inserted into a slot of the base station device 820, or may be a chip mounted on the card or the blade. Meanwhile, the RF circuit 827 may include a mixer, a filter, an amplifier, and the like, and transmits and receives a wireless signal via the antenna 810.

The wireless communication interface 825 includes a plurality of BB processors 826 as illustrated in FIG. 24, and the plurality of BB processors 826 may correspond to, for example, a plurality of frequency bands used by the eNB 800, respectively. Further, the wireless communication interface 825 includes a plurality of RF circuits 827 as illustrated in FIG. 24, and the plurality of RF circuits 827 may correspond to, for example, a plurality of antenna elements, respectively. Note that although FIG. 24 illustrates an example in which the wireless communication interface 825 includes a plurality of BB processors 826 and a plurality of RF circuits 827, the wireless communication interface 825 may include a single BB processor 826 or a single RF circuit 827.

In the eNB 800 illustrated in FIG. 24, one or more constituent elements (for example, at least one of the communication control section 151, the information acquisition section 153, the notification section 155, or the determination section 157) included in the base station 100 described with reference to FIG. 2 may be implemented in the wireless communication interface 825. Alternatively, at least some of these constituent elements may be implemented in the controller 821. As an example, the eNB 800 may be mounted with a module including a part (for example, the BB processor 826) of or the entire wireless communication interface 825 and/or the controller 821, and the one or more constituent elements described above may be implemented in the module. In this case, the above-described module may store a program for causing a processor to function as the one or more constituent elements described above (in other words, a program for causing a processor to perform an operation of the one or more constituent elements described above), and execute the program. As another example, a program for causing a processor to function as the one or more constituent elements described above may be installed in the eNB 800, and the wireless communication interface 825 (for example, the BB processor 826) and/or the controller 821 may execute the program. As described above, the eNB 800, the base station device 820, or the above-described module may be provided as a device including the one or more constituent elements described above, and a program for causing a processor to function as the one or more constituent elements described above may be provided. Further, a readable recording medium on which the above-described program is recorded may be provided.

Further, in the eNB 800 illustrated in FIG. 24, the wireless communication section 120 described with reference to FIG. 2 may be implemented in the wireless communication interface 825 (for example, the RF circuit 827). Further, the antenna section 110 may be implemented in the antenna 810. Further, the network communication section 130 may be implemented in the controller 821 and/or the network interface 823. Further, the storage section 140 may be implemented in the memory 822.

### Second Application Example

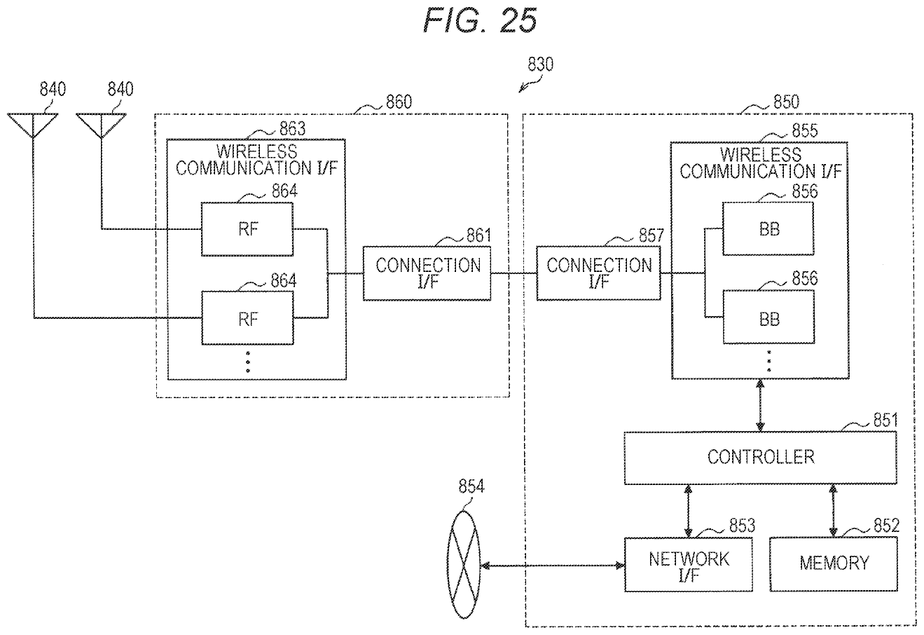

FIG. 25 is a block diagram illustrating a second example of a schematic configuration of an eNB to which the technology according to the present disclosure can be applied. An eNB 830 includes one or more antennas 840, a base station device 850, and an RRH 860. Each antenna 840 and the RRH 860 may be connected to each other via an RF cable. Further, the base station device 850 and the RRH 860 can be connected to each other by a high-speed line such as an optical fiber cable.

Each of the antennas 840 includes a single or multiple antenna elements (for example, a plurality of antenna elements constituting a MIMO antenna) and is used for transmission and reception of a wireless signal by the RRH 860. The eNB 830 includes a plurality of antennas 840 as illustrated in FIG. 25, and the plurality of antennas 840 may correspond to, for example, a plurality of frequency bands used by the eNB 830, respectively. Note that although FIG. 25 illustrates an example in which the eNB 830 includes a plurality of antennas 840, the eNB 830 may include a single antenna 840.

The base station device 850 includes a controller 851, a memory 852, a network interface 853, a wireless communication interface 855, and a connection interface 857. The controller 851, the memory 852, and the network interface 853 are similar to the controller 821, the memory 822, and the network interface 823 described with reference to FIG. 24.

The wireless communication interface 855 supports any one of cellular communication schemes such as LTE, LTE-Advanced, or the like, and provides wireless connection to a terminal located in a sector corresponding to the RRH 860 via the RRH 860 and the antenna 840. The wireless communication interface 855 may typically include a BB processor 856 and the like. The BB processor 856 is similar to the BB processor 826 described with reference to FIG. 24, except that the BB processor 856 is connected to an RF circuit 864 of the RRH 860 via the connection interface 857. The wireless communication interface 855 includes a plurality of BB processors 856 as illustrated in FIG. 25, and the plurality of BB processors 856 may correspond to, for example, a plurality of frequency bands used by the eNB 830, respectively. Note that although FIG. 25 illustrates an example in which the wireless communication interface 855 includes a plurality of BB processors 856, the wireless communication interface 855 may include a single BB processor 856.

The connection interface 857 is an interface for connecting the base station device 850 (wireless communication interface 855) to the RRH 860. The connection interface 857 may be a communication module for communication on the above-described high-speed line connecting the base station device 850 (wireless communication interface 855) and the RRH 860 to each other.

Further, the RRH 860 includes a connection interface 861 and a wireless communication interface 863.

The connection interface 861 is an interface for connecting the RRH 860 (wireless communication interface 863) to the base station device 850. The connection interface 861 may be a communication module for communication on the above-described high-speed line.

The wireless communication interface 863 transmits and receives a wireless signal via the antenna 840. The wireless communication interface 863 may typically include an RF circuit 864 and the like. The RF circuit 864 may include a mixer, a filter, an amplifier, and the like, and transmits and receives a wireless signal via the antenna 840. The wireless communication interface 863 includes a plurality of RF circuits 864 as illustrated in FIG. 25, and the plurality of RF circuits 864 may correspond to, for example, a plurality of antenna elements, respectively. Note that although FIG. 25 illustrates an example in which the wireless communication interface 863 includes a plurality of RF circuits 864, the wireless communication interface 863 may include a single RF circuit 864.

In the eNB 830 illustrated in FIG. 25, one or more constituent elements (for example, at least one of the communication control section 151, the information acquisition section 153, the notification section 155, or the determination section 157) included in the base station 100 described with reference to FIG. 2 may be implemented in the wireless communication interface 855 and/or the wireless communication interface 863. Alternatively, at least some of these constituent elements may be implemented in the controller 851. As an example, the eNB 830 may be mounted with a module including a part (for example, the BB processor 856) of or the entire wireless communication interface 855 and/or the controller 851, and the one or more constituent elements described above may be implemented in the module. In this case, the above-described module may store a program for causing a processor to function as the one or more constituent elements described above (in other words, a program for causing a processor to perform an operation of the one or more constituent elements described above), and execute the program. As another example, a program for causing a processor to function as the one or more constituent elements described above may be installed in the eNB 830, and the wireless communication interface 855 (for example, the BB processor 856) and/or the controller 851 may execute the program. As described above, the eNB 830, the base station device 850, or the above-described module may be provided as a device including the one or more constituent elements described above, and a program for causing a processor to function as the one or more constituent elements described above may be provided. Further, a readable recording medium on which the above-described program is recorded may be provided.

Further, in the eNB 830 illustrated in FIG. 25, for example, the wireless communication section 120 described with reference to FIG. 2 may be implemented in the wireless communication interface 863 (for example, the RF circuit 864). Further, the antenna section 110 may be implemented in the antenna 840. Further, the network communication section 130 may be implemented in the controller 851 and/or the network interface 853. Further, the storage section 140 may be implemented in the memory 852.

<5.2. Application Example Related to Terminal Device>

### First Application Example

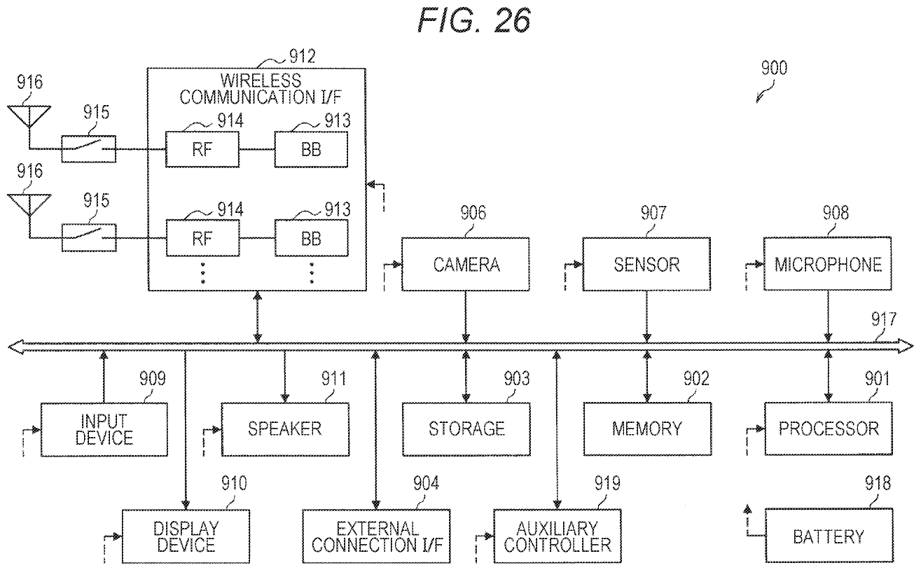

FIG. 26 is a block diagram illustrating an example of a schematic configuration of a smartphone 900 to which the technology according to the present disclosure can be applied. The smartphone 900 includes a processor 901, a memory 902, a storage 903, an external connection interface 904, a camera 906, a sensor 907, a microphone 908, an input device 909, a display device 910, a speaker 911, a wireless communication interface 912, one or more antenna switches 915, one or more antennas 916, a bus 917, a battery 918, and an auxiliary controller 919.

The processor 901 may be, for example, a CPU or a system on chip (SoC), and controls functions of an application layer and other layers of the smartphone 900. The memory 902 includes a RAM and a ROM and stores a program executed by the processor 901 and data. The storage 903 can include a storage medium such as a semiconductor memory or a hard disk. The external connection interface 904 is an interface for connecting an externally attached device such as a memory card, a universal serial bus (USB) device, or the like to the smartphone 900.

The camera 906 includes, for example, an image capturing element such as a charge coupled device (CCD), a complementary metal oxide semiconductor (CMOS), or the like, and generates a captured image. The sensor 907 can include, for example, a group of sensors such as a positioning sensor, a gyro sensor, a geomagnetic sensor, an acceleration sensor, and the like. The microphone 908 converts sound input to the smartphone 900 into a sound signal. The input device 909 includes, for example, a touch sensor that detects a touch on a screen of the display device 910, a keypad, a keyboard, a button, a switch, or the like, and receives a manipulation or information input from the user. The display device 910 includes a screen such as a liquid crystal display (LCD), an organic light emitting diode (OLED) display, or the like, and displays an output image of the smartphone 900. The speaker 911 converts the sound signal output from the smartphone 900 into sound.

The wireless communication interface 912 supports any cellular communication scheme such as LTE or LTE-Advanced and performs wireless communication. The wireless communication interface 912 can typically include a BB processor 913, an RF circuit 914, and the like. The BB processor 913 may perform, for example, encoding/decoding, modulation/demodulation, multiplexing/demultiplexing, and the like, and performs various signal processing for wireless communication. Meanwhile, the RF circuit 914 may include a mixer, a filter, an amplifier, and the like, and transmits and receives a wireless signal via the antenna 916. The wireless communication interface 912 may be a one-chip module in which the BB processor 913 and the RF circuit 914 are integrated. The wireless communication interface 912 may include a plurality of BB processors 913 and a plurality of RF circuits 914 as illustrated in FIG. 26. Note that although FIG. 26 illustrates an example in which the wireless communication interface 912 includes a plurality of BB processors 913 and a plurality of RF circuits 914, the wireless communication interface 912 may include a single BB processor 913 or a single RF circuit 914.

Moreover, the wireless communication interface 912 may support another type of wireless communication scheme such as a short-range wireless communication scheme, a near field wireless communication scheme, a wireless local area network (LAN) scheme, or the like, in addition to the cellular communication scheme. In that case, the wireless communication interface 912 may include the BB processor 913 and the RF circuit 914 for each wireless communication scheme.

Each of the antenna switches 915 switches a connection destination of the antenna 916 between a plurality of circuits (for example, circuits for different wireless communication schemes) included in the wireless communication interface 912.

Each of the antennas 916 includes a single or multiple antenna elements (for example, a plurality of antenna elements constituting a MIMO antenna) and is used for transmission and reception of a wireless signal by the wireless communication interface 912. The smartphone 900 may include a plurality of antennas 916 as illustrated in FIG. 26. Note that although FIG. 26 illustrates an example in which the smartphone 900 includes a plurality of antennas 916, the smartphone 900 may include a single antenna 916.

Moreover, the smartphone 900 may include the antenna 916 for each wireless communication scheme. In that case, the antenna switch 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the wireless communication interface 912, and the auxiliary controller 919 to one another. The battery 918 supplies power to each block of the smartphone 900 illustrated in FIG. 26 via a power supply line partially indicated by the broken line in FIG. 26. The auxiliary controller 919 performs control to operate minimum necessary functions of the smartphone 900, for example, in a sleep mode.

In the smartphone 900 illustrated in FIG. 26, one or more constituent elements (for example, at least one of the communication control section 241, the information acquisition section 243, the detection control section 245, or the notification section 247) included in the terminal device 200 described with reference to FIG. 3 may be implemented in the wireless communication interface 912. Alternatively, at least some of these constituent elements may be implemented in the processor 901 or the auxiliary controller 919. As an example, the smartphone 900 may be mounted with a module including a part (for example, the BB processor 913) of or the entire wireless communication interface 912, the processor 901, and/or the auxiliary controller 919, and the one or more constituent elements described above may be implemented in the module. In this case, the above-described module may store a program for causing a processor to function as the one or more constituent elements described above (in other words, a program for causing a processor to perform an operation of the one or more constituent elements described above), and execute the program. As another example, a program for causing a processor to function as the one or more constituent elements described above may be installed in the smartphone 900, and the wireless communication interface 912 (for example, the BB processor 913), the processor 901, and/or the auxiliary controller 919 may execute the program. As described above, the smartphone 900 or the above-described module may be provided as a device including the one or more constituent elements described above, and a program for causing a processor to function as the one or more constituent elements described above may be provided. Further, a readable recording medium on which the above-described program is recorded may be provided.

Further, in the smartphone 900 illustrated in FIG. 26, for example, the wireless communication section 220 described with reference to FIG. 3 may be implemented in the wireless communication interface 912 (for example, the RF circuit 914). Further, the antenna section 210 may be implemented in the antenna 916. Further, the storage section 230 may be implemented in the memory 902.

### Second Application Example

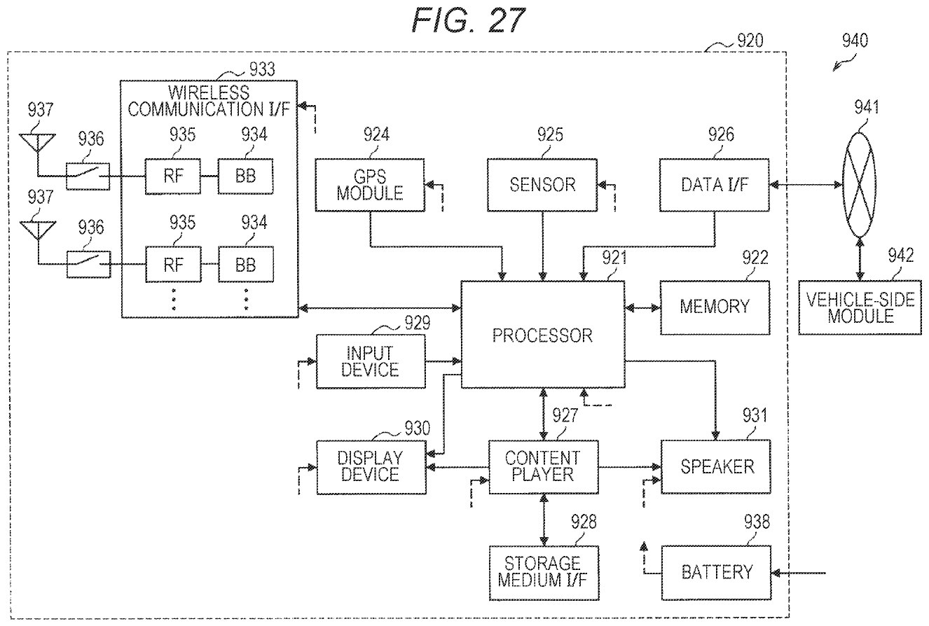

FIG. 27 is a block diagram illustrating an example of a schematic configuration of a car navigation device 920 to which the technology according to the present disclosure can be applied. The car navigation device 920 includes a processor 921, a memory 922, a global positioning system (GPS) module 924, a sensor 925, a data interface 926, a content player 927, a storage medium interface 928, an input device 929, a display device 930, a speaker 931, a wireless communication interface 933, one or more antenna switches 936, one or more antennas 937, and a battery 938.

The processor 921 may be, for example, a CPU or an SoC, and controls a navigation function and other functions of the car navigation device 920. The memory 922 includes a RAM and a ROM and stores a program executed by the processor 921 and data.

The GPS module 924 uses a GPS signal received from a GPS satellite to measure a location (for example, latitude, longitude, and altitude) of the car navigation device 920. The sensor 925 can include, for example, a group of sensors such as a gyro sensor, a geomagnetic sensor, an atmospheric pressure sensor, and the like. The data interface 926 is connected to an in-vehicle network 941 via a terminal (not illustrated), for example, and acquires data generated in a vehicle side, such as vehicle speed data or the like.

The content player 927 plays a content stored in a storage medium (for example, a CD or a DVD) to be inserted into the storage medium interface 928. The input device 929 includes, for example, a touch sensor that detects a touch on a screen of the display device 930, a button, a switch, or the like, and receives a manipulation or information input from the user. The display device 930 includes a screen such as an LCD, an OLED display, or the like and displays the navigation function or an image of a content to be played. The speaker 931 outputs sound of the navigation function or a content to be played.

The wireless communication interface 933 supports any cellular communication scheme such as LTE or LTE-Advanced and performs wireless communication. The wireless communication interface 933 can typically include a BB processor 934, an RF circuit 935, and the like. The BB processor 934 may perform, for example, encoding/decoding, modulation/demodulation, multiplexing/demultiplexing, and the like, and performs various signal processing for wireless communication. Meanwhile, the RF circuit 935 may include a mixer, a filter, an amplifier, and the like, and transmits and receives a wireless signal via the antenna 937. The wireless communication interface 933 may be a one-chip module in which the BB processor 934 and the RF circuit 935 are integrated. The wireless communication interface 933 may include a plurality of BB processors 934 and a plurality of RF circuits 935 as illustrated in FIG. 27. Note that although FIG. 27 illustrates an example in which the wireless communication interface 933 includes a plurality of BB processors 934 and a plurality of RF circuits 935, the wireless communication interface 933 may include a single BB processor 934 or a single RF circuit 935.

Moreover, the wireless communication interface 933 may support another type of wireless communication scheme such as a short-range wireless communication scheme, a near field wireless communication scheme, a wireless LAN scheme, or the like, in addition to the cellular communication scheme. In that case, the wireless communication interface 933 may include the BB processor 934 and the RF circuit 935 for each wireless communication scheme.

Each of the antenna switches 936 switches a connection destination of the antenna 937 between a plurality of circuits (for example, circuits for different wireless communication schemes) included in the wireless communication interface 933.

Each of the antennas 937 includes a single or multiple antenna elements (for example, a plurality of antenna elements constituting a MIMO antenna) and is used for transmission and reception of a wireless signal by the wireless communication interface 933. The car navigation device 920 may include a plurality of antennas 937 as illustrated in FIG. 27. Note that although FIG. 27 illustrates an example in which the car navigation device 920 includes a plurality of antennas 937, the car navigation device 920 may include a single antenna 937.

Moreover, the car navigation device 920 may include the antenna 937 for each wireless communication scheme. In that case, the antenna switch 936 may be omitted from the configuration of the car navigation device 920.

The battery 938 supplies power to each block of the car navigation device 920 illustrated in FIG. 27 via a power supply line partially indicated by the broken line in FIG. 27. In addition, the battery 938 accumulates power supplied from the vehicle side.

In the car navigation device 920 illustrated in FIG. 27, one or more constituent elements (for example, at least one of the communication control section 241, the information acquisition section 243, the detection control section 245, or the notification section 247) included in the terminal device 200 described with reference to FIG. 3 may be implemented in the wireless communication interface 933. Alternatively, at least some of these constituent elements may be implemented in the processor 921. As an example, the car navigation device 920 may be mounted with a module including a part (for example, the BB processor 934) of or the entire wireless communication interface 933 and/or the processor 921, and the one or more constituent elements described above may be implemented in the module. In this case, the above-described module may store a program for causing a processor to function as the one or more constituent elements described above (in other words, a program for causing a processor to perform an operation of the one or more constituent elements described above), and execute the program. As another example, a program for causing a processor to function as the one or more constituent elements described above may be installed in the car navigation device 920, and the wireless communication interface 933 (for example, the BB processor 934) and/or the processor 921 may execute the program. As described above, the car navigation device 920 or the above-described module may be provided as a device including the one or more constituent elements described above, and a program for causing a processor to function as the one or more constituent elements described above may be provided. Further, a readable recording medium on which the above-described program is recorded may be provided.

Further, in the car navigation device 920 illustrated in FIG. 27, for example, the wireless communication section 220 described with reference to FIG. 3 may be implemented in the wireless communication interface 933 (for example, the RF circuit 935). Further, the antenna section 210 may be implemented in the antenna 937. Further, the storage section 230 may be implemented in the memory 922.

Further, the technology according to the present disclosure may be realized as an in-vehicle system (or vehicle) 940 including one or more blocks of the car navigation device 920 described above, the in-vehicle network 941, and a vehicle-side module 942. The vehicle-side module 942 generates vehicle-side data such as a vehicle speed, an engine RPM, failure information, and the like and outputs the generated data to the in-vehicle network 941.

### 6. CONCLUSION

As described above, a communication device (for example, the radar device 350) according to an embodiment of the present disclosure includes a communication section that performs wireless communication, an acquisition section that acquires, from another communication device through the wireless communication, information regarding detection of an object based on reflected waves obtained by reflection of a transmitted wireless signal (for example, a chirp signal) from the object, and a control section that controls an operation related to the detection on the basis of the acquired information. Further, a communication device (for example, the base station 100 or the master device 350D) according to an embodiment of the present disclosure includes a communication section that performs wireless communication, and a notification section that notifies a terminal device (for example, the radar device 350) of information regarding detection of an object based on reflected waves obtained by reflection of a transmitted wireless signal from the object, through the wireless communication.

With the configuration as described above, the system according to an embodiment of the present disclosure can further reduce the influence of interference even in a situation where, for example, the influence of interference between radars (between vehicles) becomes apparent more easily with the spread of the in-vehicle radar. That is, by reducing the influence of interference between radars, it is possible to further suppress the appearance of a virtual image. Further, with the system according to an embodiment of the present disclosure, it is possible to more efficiently allocate a resource available for transmitting a wireless signal (for example, a chirp signal) to each radar device.

Hereinabove, the preferred embodiment of the present disclosure has been described in detail with reference to the accompanying drawings, but the technical scope of the present disclosure is not limited to such examples. It is obvious that those having ordinary knowledge in the technical field of the present disclosure can conceive of various modifications or alterations within the scope of the technical idea described in the claims, and it is understood that the modifications or alterations naturally fall within the technical scope of the present disclosure.

Furthermore, the effects described in the present specification are merely illustrative or exemplary, and not limiting. That is, the technology according to the present disclosure may achieve other effects apparent to those skilled in the art from the description of the present specification, in addition to or instead of the effects described above.

Note that the following configurations also fall within the technical scope of the present disclosure.

(1)

A communication device including:

a communication section that performs wireless communication;

an acquisition section that acquires, from another communication device through the wireless communication, information regarding detection of an object based on reflected waves obtained by reflection of a transmitted wireless signal from the object; and

a control section that controls an operation related to the detection on the basis of the acquired information.

(2)

The communication device according to (1), in which the information regarding the detection includes information regarding a resource available for transmitting the wireless signal, and

the control section selects the resource to be used for transmitting the wireless signal on the basis of the information regarding the resource.

(3)

The communication device according to (2), in which a different resource is allocated according to a distance to the object to be detected by using the wireless signal, and

the control section selects the resource to be used for transmitting the wireless signal on the basis of the information regarding the resource and the distance to the object to be detected.

(4)

The communication device according to (2) or (3), further including a notification section that notifies the another communication device of information regarding a resource desired to be allocated.

(5)

The communication device according to any one of (1) to (4), in which the information regarding the detection includes information regarding a transmission timing of the wireless signal, and

the control section controls the transmission timing of the wireless signal on the basis of the information regarding the transmission timing.

(6)

The communication device according to (5), further including a notification section that notifies another communication device of information regarding a desired transmission timing of the wireless signal.

(7)

The communication device according to any one of (1) to (6), in which the wireless signal is controlled so that a frequency changes continuously in time series within a period having a first time width, and

the control section performs a control so that the wireless signal is transmitted at one of a plurality of transmission timings set for each period having a second time width smaller than the first time width.

(8)

The communication device according to (7), in which the control section performs a control so that a location of the object is detected on the basis of a result of reception of the reflected waves within a period having a third time width equal to or smaller than the second time width from the transmission timing of the wireless signal.

(9)

The communication device according to (7) or (8), in which the wireless signal is a chirp signal controlled so that a frequency continuously increases or decreases in time series.

(10)

The communication device according to any one of (1) to (9), in which the another communication device is a base station.

(11)

The communication device according to any one of (1) to (9), in which the another communication device is a terminal device configured to perform communication with a base station through wireless communication.

(12)

The communication device according to any one of (1) to (11), in which the communication device is configured as a mobile object.

(13)

A communication device including:

a communication section that performs wireless communication; and

a notification section that notifies a terminal device of information regarding detection of an object based on reflected waves obtained by reflection of a transmitted wireless signal from the object, through the wireless communication.

(14)

The communication device according to (13), further including a control section that allocates a resource available for transmitting the wireless signal,

in which the information regarding the detection includes information regarding the allocated resource.

(15)

The communication device according to (14), in which the control section controls, according to a distance to the object to be detected by using the wireless signal, at least one of a width of a region, in which the resource available for transmitting the wireless signal is allocated, in a time direction or a width of the region in a frequency direction.

(16)

The communication device according to (15), in which the control section performs a control so that the width of the region, in which the resource available for transmitting the wireless signal is allocated, in the time direction is increased, as the distance to the object to be detected by using the wireless signal increases.

(17)

The communication device according to (15) or (16), in which the control section performs a control so that the width of the region, in which the resource available for transmitting the wireless signal is allocated, in the frequency direction, is increased, as the distance to the object to be detected by using the wireless signal decreases.

(18)

The communication device according to any one of (14) to (17), in which the control section allocates, as the resource available for transmitting the wireless signal, a different resource according to the distance to the object to be detected by using the wireless signal.

(19)

The communication device according to any one of (14) to (18), in which the control section allocates, as the resource available for transmitting the wireless signal, a resource in a lower frequency band, as the distance to the object to be detected by using the wireless signal increases.

(20)

The communication device according to any one of (14) to (19), in which the control section allocates, as the resource available for transmitting the wireless signal, a resource included in any one of a plurality of different regions.

(21)

The communication device according to any one of (13) to (20), in which the communication device is a first terminal device that is operated as a master device among a plurality of terminal devices, and

the notification section notifies a second terminal device different from the first terminal device of the information regarding the detection.

(22)

The communication device according to (21), in which the communication device is operated as the master device in response to a request from a base station.

(23)

The communication device according to (22), further including an acquisition section that acquires information regarding a surrounding environment,

in which the notification section notifies the base station of the information regarding the surrounding environment in response to the request from the base station.

(24)

The communication device according to any one of (13) to (20), in which the communication device is a base station.

(25)

The communication device according to (24), further including:

an acquisition section that acquires, from at least some of one or more of the terminal devices, information regarding a surrounding environment of the at least some terminal devices; and

a selection section that selects, on the basis of the information regarding the surrounding environment, a terminal device to be operated as the master device among one or more of the terminal devices from which the information regarding the surrounding environment is acquired,

in which the notification section notifies the selected terminal device of information regarding a request for the operation as the master device.

(26)

A communication method performed by a computer, the communication method including:

performing wireless communication;

acquiring, from another communication device through the wireless communication, information regarding detection of an object based on reflected waves obtained by reflection of a transmitted wireless signal from the object; and

controlling an operation related to the detection on the basis of the acquired information.

(27)

A communication method performed by a computer, the communication method including:

performing wireless communication; and

notifying a terminal device of information regarding detection of an object based on reflected waves obtained by reflection of a transmitted wireless signal from the object, through the wireless communication.

(28)

A detection device including:

a communication control section that performs a control so that a wireless signal controlled so that a frequency continuously changes in time series within a period having a first time width is transmitted at any one of a plurality of transmission timings set for each period having a second time width smaller than the first time width, and reflected waves of the wireless signal are received; and

a detection section that detects a location of an object on the basis of a result of reception of the reflected waves within a period having a third time width equal to or smaller than the second time width from the transmission timing of the wireless signal.

### REFERENCE SIGNS LIST

1 System
100 Base station
110 Antenna section
120 Wireless communication section
130 Network communication section
140 Storage section
150 Control section
151 Communication control section
153 Information acquisition section
155 Notification section
157 Determination section
200 Terminal device
210 Antenna section
220 Wireless communication section
230 Storage section
240 Control section
241 Communication control section
243 Information acquisition section
245 Detection control section
247 Notification section
250 Detection section
190 Central control system
191 Central control device
193 Timing control section
195 Resource management section
350 Radar device
351 Communication section
353 Control section
355 Radar unit

1. A communication device comprising:
a communication section that performs wireless communication;
an acquisition section that acquires, from another communication device through the wireless communication, information regarding detection of an object based on reflected waves obtained by reflection of a transmitted wireless signal from the object; and
a control section that controls an operation related to the detection on a basis of the acquired information.

2. The communication device according to claim 1, wherein the information regarding the detection includes information regarding a resource available for transmitting the wireless signal, and
the control section selects the resource to be used for transmitting the wireless signal on a basis of the information regarding the resource.

3. The communication device according to claim 2, wherein a different resource is allocated according to a distance to the object to be detected by using the wireless signal, and
the control section selects the resource to be used for transmitting the wireless signal on a basis of the information regarding the resource and the distance to the object to be detected.

4. The communication device according to claim 2, further comprising a notification section that notifies the another communication device of information regarding a resource desired to be allocated.

5. The communication device according to claim 1, wherein the information regarding the detection includes information regarding a transmission timing of the wireless signal, and
the control section controls the transmission timing of the wireless signal on a basis of the information regarding the transmission timing.

6. The communication device according to claim 1, wherein the wireless signal is controlled so that a frequency changes continuously in time series within a period having a first time width, and
the control section performs a control so that the wireless signal is transmitted at one of a plurality of transmission timings set for each period having a second time width smaller than the first time width.

7. The communication device according to claim 6, wherein the control section performs a control so that a location of the object is detected on a basis of a result of reception of the reflected waves within a period having a third time width equal to or smaller than the second time width from the transmission timing of the wireless signal.

8. The communication device according to claim 6, wherein the wireless signal is a chirp signal controlled so that a frequency continuously increases or decreases in time series.

9. A communication device comprising:
a communication section that performs wireless communication; and
a notification section that notifies a terminal device of information regarding detection of an object based on reflected waves obtained by reflection of a transmitted wireless signal from the object, through the wireless communication.

10. The communication device according to claim 9, further comprising a control section that allocates a resource available for transmitting the wireless signal,
wherein the information regarding the detection includes information regarding the allocated resource.

11. The communication device according to claim 10, wherein the control section controls, according to a distance to the object to be detected by using the wireless signal, at least one of a width of a region, in which the resource available for transmitting the wireless signal is allocated, in a time direction or a width of the region in a frequency direction.

12. The communication device according to claim 10, wherein the control section allocates, as the resource available for transmitting the wireless signal, a different resource according to the distance to the object to be detected by using the wireless signal.

13. The communication device according to claim 10, wherein the control section allocates, as the resource available for transmitting the wireless signal, a resource in a lower frequency band, as a distance to the object to be detected by using the wireless signal increases.

14. The communication device according to claim 10, wherein the control section allocates, as the resource available for transmitting the wireless signal, a resource included in any one of a plurality of different regions.

15. The communication device according to claim 9, wherein the communication device is a first terminal device that is operated as a master device among a plurality of terminal devices, and
the notification section notifies a second terminal device different from the first terminal device of the information regarding the detection.

16. The communication device according to claim 15, wherein the communication device is operated as the master device in response to a request from a base station.

17. The communication device according to claim 9, further comprising:
an acquisition section that acquires, from at least some of one or more of the terminal devices, information regarding a surrounding environment of the at least some terminal devices; and
a selection section that selects, on a basis of the information regarding the surrounding environment, a terminal device to be operated as the master device among one or more of the terminal devices from which the information regarding the surrounding environment is acquired,
wherein the notification section notifies the selected terminal device of information regarding a request for an operation as the master device.

18. A communication method performed by a computer, the communication method comprising:
performing wireless communication;
acquiring, from another communication device through the wireless communication, information regarding detection of an object based on reflected waves obtained by reflection of a transmitted wireless signal from the object; and
controlling an operation related to the detection on a basis of the acquired information.

19. A communication method performed by a computer, the communication method comprising:
performing wireless communication; and
notifying a terminal device of information regarding detection of an object based on reflected waves obtained by reflection of a transmitted wireless signal from the object, through the wireless communication.
